(19) United States
(12) Patent Application Publication
(10) Pub. No.: US 2018/0032181 A1
(43) Pub. Date: Feb. 1, 2018

(54) FORCE-SENSING CAPACITOR ELEMENTS, DEFORMABLE MEMBRANES AND ELECTRONIC DEVICES FABRICATED THEREFROM

(71) Applicant: 3M INNOVATIVE PROPERTIES COMPANY, St. Paul, MN (US)

(72) Inventors: Matthew H. Frey, Cottage Grove, MN (US); Brian W. Lueck, Houlton, WI (US); Kenneth A. P. Meyer, White Bear Township, MN (US)

(21) Appl. No.: 15/727,922

(22) Filed: Oct. 9, 2017

Related U.S. Application Data
(62) Division of application No. 15/325,637, filed on Jan. 11, 2017.
(60) Provisional application No. 62/034,206, filed on Aug. 7, 2014.

(51) Int. Cl. G06F 3/044; G06F 3/041; G01L 1/14

(52) U.S. Cl. CPC G06F 3/044; G01L 1/142; G06F 3/0414

(57) ABSTRACT

Force-sensing capacitor elements and deformable membranes useful in electronic devices that include touch screen displays or other touch sensors. The deformable membranes, generally, include a first, second, and third layers with a first arrangement of a plurality of first structures interposed between the first and third layers and a second arrangement of one or more second structures interposed between the second and third layers. Electrodes may be included proximate to or in contact with one or more of the major surfaces of the first, second, and third layers or embedded within one or more of the second and third layers of the deformable membranes, yielding force-sensing capacitor elements. The electrodes proximate to or in contact with the one or more of the major surfaces of the first and second layers or embedded within one or more of the second and third layers may be one or more plurality of electrodes.

### BACKGROUND

Force-sensing capacitor elements have been contemplated or applied for many years in touch displays, keyboards, touch pads, and other electronic devices. The recent renaissance of the touch user interface (paradigm shift from resistive to projected capacitive) has catalyzed a renewed interest among electronic device makers to consider force-sensing. The main challenges associated with the integration of force-sensing with the display of an electronic device, for example, include linearity of response, speed of response and speed of recovery, preservation of device mechanical robustness, preservation of device hermiticity where desired, thinness of construction, sensitivity, determination of position or positions of force application, and noise rejection. The capacitors of the present disclosure have advantages in the areas, for example, of response speed and recovery speed, linearity of response, thinness, and determination of touch position.

### SUMMARY

The present disclosure relates to force-sensing capacitor elements useful, for example, in electronic devices that include, for example touch screen displays or other touch sensors. The present disclosure also relates to deformable membranes useful in the fabrication of the force-sensing capacitor elements. Force-sensing (and also force-measuring) capacitor elements are provided with electrodes and deformable membranes (e.g., insulators) having specific design features. The capacitor elements can be integrated within a display or electronic device, for example, to detect and measure the magnitude and/or direction of force or pressure applied to the display or electronic device. The capacitor elements can be integrated, for example, at the periphery of or beneath a display, to sense or measure force applied to the display. Alternatively, the capacitor elements can be integrated within a touch pad, keyboard, or digitizer (e.g., stylus input device), for example.

In one aspect, the present disclosure provides a force-sensing capacitor element comprising:
a deformable membrane comprising
   a first layer having first and second major surfaces,
   a second layer having first and second major surfaces,
   a third layer having first and second major surfaces interposed between the second major surface of the first layer and the second major surface of the second layer,
   a first arrangement comprising a plurality of first structures, with corresponding first void regions, interposed between the second major surface of the first layer and the first major surface of the third layer, wherein each first structure has a first surface facing the second major surface of the first layer and a second surface facing the first major surface of the third layer, and
   a second arrangement comprising one or more second structures, with corresponding second void regions, interposed between the second major surface of the second layer and the second major surface of the third layer, wherein each of the one or more second structures has a first surface facing the second major surface of the second layer and a second surface facing the second major surface of the third layer; and wherein each first surface of the first structures and each first surface of the one or more second structures are offset from one another such that there is no overlap between each first surface of the first structures and each first surface of the one or more second structures, through the thickness of the deformable membrane;
a first electrode embedded within the first layer or proximate to or in contact with the first major surface of the first layer; and
a second electrode embedded within the second layer or proximate to or in contact with one of the first major surface of the second layer and the second major surface of the second layer.

In another aspect, the present disclosure provides a force-sensing capacitor element comprising:
a deformable membrane comprising
   a first layer having first and second major surfaces,
   a second layer having first and second major surfaces,
   a third layer having first and second major surfaces interposed between the second major surface of the first layer and the second major surface of the second layer,
   a first arrangement comprising a plurality of first structures, with corresponding first void regions, interposed between the second major surface of the first layer and the first major surface of the third layer, wherein each first structure has a first surface facing the second major surface of the first layer and a second surface facing the first major surface of the third layer, and
   a second arrangement comprising one or more second structures, with corresponding second void regions, interposed between the second major surface of the second layer and the second major surface of the third layer, wherein each of the one or more second structures has a first surface facing the second major surface of the second layer and a second surface facing the second major surface of the third layer; and wherein each first surface of the first structures and each first surface of the one or more second structures are offset from one another such that there is no overlap between each first surface of the first structures and each first surface of the one or more second structures, through the thickness of the deformable membrane; and
at least one electrode pair embedded within the second layer or proximate to or in contact with at least one of the first and second major surfaces of the second layer, wherein each of the at least one electrode pair comprises a first electrode and a second electrode separated by a gap and each of the at least one electrode pair is aligned with a second void region of the second arrangement, through the thickness of the deformable membrane.

In another aspect, the present disclosure provides a force-sensing capacitor element comprising:
a deformable membrane comprising
   a first layer having first and second major surfaces,
   a second layer having first and major second surfaces,
   a third layer having first and second major surfaces interposed between the second major surface of the first layer and the second major surface of the second layer,
   a first arrangement comprising a plurality of first structures, with corresponding first void regions, interposed between the second major surface of the first layer and the first major surface of the third layer, wherein each first structure has a first surface facing the second major surface of the first layer and a second surface facing the first major surface of the third layer, and
   a second arrangement comprising one or more second structures, with corresponding second void regions, interposed between the second major surface of the second layer and the second major surface of the third layer, wherein each of the one or more second structures has a first surface facing the second major surface of the second layer and a second surface facing the second major surface of the third layer; and wherein each first surface of the first structures and each first surface of the one or more second structures are offset from one another such that there is no overlap between each first surface of the first structures and each first surface of the one or more second structures, through the thickness of the deformable membrane;
a plurality of first electrodes embedded within the third layer or proximate to or in contact with one of the first and second major surfaces of the third layer wherein each first electrode is aligned with a discrete second void region of the second arrangement comprising one or more structures; and
at least one of (i) a plurality of second electrodes embedded within the second layer or proximate to or in contact with one of the first and second major surfaces of the second layer, wherein each second electrode is aligned, through the thickness of the deformable membrane, with a discrete second void region corresponding to a first electrode and, optionally, is aligned with a first electrode through the thickness of the deformable membrane; and (ii) a third electrode embedded within the second layer or proximate to or in contact with one of the first and second major surfaces of the second layer, wherein the third electrode is aligned, through the thickness of the deformable membrane, with at least two discrete second void regions, and optionally, is aligned with at least two first electrodes, through the thickness of the deformable membrane.

In another aspect, the present disclosure provides a force-sensing capacitor element comprising:
a deformable membrane comprising
   a first layer having first and second major surfaces,
   a second layer having first and major second surfaces,
   a third layer having first and second major surfaces interposed between the second major surface of the first layer and the second major surface of the second layer,
   a first arrangement comprising a plurality of first structures, with corresponding first void regions, interposed between the second major surface of the first layer and the first major surface of the third layer, wherein each first structure has a first surface facing the second major surface of the first layer and a second surface facing the first major surface of the third layer, and
   a second arrangement comprising one or more second structures, with corresponding second void regions, interposed between the second major surface of the second layer and the second major surface of the third layer, wherein each of the one or more second structures has a first surface facing the second major surface of the second layer and a second surface facing the second major surface of the third layer; and wherein each first surface of the first structures and each first surface of the one or more second structures are offset from one another such that there is no overlap between each first surface of the first structures and each first surface of the one or more second structures, through the thickness of the deformable membrane;
a plurality of first electrodes embedded within the second layer or proximate to or in contact with one of the first and second major surfaces of the second layer wherein each first electrode is aligned with a discrete second void region of the second arrangement comprising one or more structures; and
a second electrode embedded within the third layer or proximate to or in contact with one of the first and second major surfaces of the third layer, wherein the second electrode is aligned, through the thickness of the deformable membrane, with at least two discrete second void regions corresponding to at least two first electrodes and, optionally, is aligned with at least one first electrode, through the thickness of the deformable membrane.

In another aspect, the present disclosure provides a force-sensing capacitor element comprising:
a deformable membrane comprising
   a first layer having first and second major surfaces,
   a second layer having first and second major surfaces,
   a third layer having first and second major surfaces interposed between the second major surface of the first layer and the second major surface of the second layer,
   a first arrangement comprising a plurality of first structures, with corresponding first void regions, interposed between the second major surface of the first layer and the first major surface of the third layer, wherein each first structure has a first surface facing the second major surface of the first layer and a second surface facing the first major surface of the third layer, and
   a second arrangement comprising one or more second structures, with corresponding second void regions, interposed between the second major surface of the second layer and the second major surface of the third layer, wherein each of the one or more second structures has a first surface facing the second major surface of the second layer and a second surface facing the second major surface of the third layer; and wherein each first surface of the first structures and each first surface of the one or more second structures are offset from one another such that there is no overlap between each first surface of the first structures and each first surface of the one or more second structures, through the thickness of the deformable membrane;
a first electrode embedded within the second layer or proximate to or in contact with one of the first and second major surfaces of the second layer wherein the first electrode is aligned, through the thickness of the deformable membrane, with two or more discrete second void regions of the second arrangement; and
a second electrode embedded within the third layer or proximate to or in contact with one of the first and second major surfaces of the third layer, wherein the second electrode is aligned, through the thickness of the deformable membrane, with at least one discrete second void region corresponding to the first electrode and, optionally, is aligned with the first electrode, through the thickness of the deformable membrane.

In yet another aspect, the present disclosure provides a deformable membrane for a force-sensing capacitor element comprising:
a first layer having first and second major surfaces;
a second layer having first and major second surfaces;
a third layer having first and second major surfaces interposed between the second major surface of the first layer and the second major surface of the second layer;
a first arrangement comprising a plurality of first structures, with corresponding first void regions, interposed between the second major surface of the first layer and the first major surface of the third layer, wherein each first structure has a first surface facing the second major surface of the first layer and a second surface facing the first major surface of the third layer;
a second arrangement comprising one or more second structures, with corresponding second void regions, interposed between the second major surface of the second layer and the second major surface of the third layer, wherein each of the one or more second structures has a first surface facing the second major surface of the second layer and a second surface facing the second major surface of the third layer; and wherein each first surface of the first structures and each first surface of the one or more second structures are offset from one another such that there is no overlap between each first surface of the first structures and each first surface of the one or more second structures, through the thickness of the deformable membrane; and
a plurality of third structures to or in contact with the second major surface of the third layer wherein each third structure coincides and overlaps, through the thickness of the deformable membrane, with a corresponding first structure of the first arrangement, and the third structures are located in the void regions of the second arrangement.

In another aspect, the present disclosure provides a deformable membrane for a force-sensing capacitor element comprising:
a first layer having first and second major surfaces;
a second layer having first and major second surfaces;
a third layer having first and second major surfaces interposed between the second major surface of the first layer and the second major surface of the second layer;
a first arrangement comprising a plurality of first structures, with corresponding first void regions, interposed between the second major surface of the first layer and the first major surface of the third layer, wherein each first structure has a first surface facing the second major surface of the first layer and a second surface facing the first major surface of the third layer, and wherein the first structures of the first arrangement have corresponding imaginary axes aligned perpendicular to and running through the centroids of their first surfaces;
a second arrangement comprising one or more second structures, with corresponding second void regions, interposed between the second major surface of the second layer and the second major surface of the third layer, wherein each of the one or more second structures has a first surface facing the second major surface of the second layer and a second surface facing the second major surface of the third layer; and wherein each first surface of the first structures and each first surface of the one or more second structures are offset from one another such that there is no overlap between each first surface of the first structures and each first surface of the one or more second structures, through the thickness of the deformable membrane, and wherein at least one of the imaginary axes of the first structures of the first arrangement is surrounded by the one or more second structures of the second arrangement such that an imaginary circle in a region of the second arrangement, having a radius r drawn around the at least one of the imaginary axes, intersects the at least one or more second structures of the second arrangement along at least 50% of the circle's circumference length.

In yet another aspect, the present disclosure provides an electronic device comprising a force-sensing capacitor element.

In still another aspect, the present disclosure provides a touch screen display comprising a force-sensing capacitor element.

### BRIEF DESCRIPTION OF THE DRAWINGS

FIG. 1A is a schematic cross-sectional side view of an exemplary deformable membrane according to one exemplary embodiment of the present disclosure.

FIG. 1B is a schematic cross-sectional side view of cut-out 190 of the exemplary deformable membrane of FIG. 1A of the present disclosure.

FIG. 1C is a schematic cross-sectional side view of the exemplary deformable membrane of FIG. 1A in compression, due to an applied force.

FIG. 1D is a schematic cross-sectional side view of an exemplary deformable membrane according to one exemplary embodiment of the present disclosure.

FIG. 1E is a schematic cross-sectional side view of an exemplary deformable membrane according to one exemplary embodiment of the present disclosure.

FIG. 1F is a schematic cross-sectional side view of an exemplary deformable membrane according to one exemplary embodiment of the present disclosure.

FIG. 2 is a schematic cross-sectional side view of an exemplary deformable membrane according to one exemplary embodiment of the present disclosure.

FIG. 3A is a schematic cross-sectional top view of an exemplary deformable membrane, through a plane of arrangement 150, according to one exemplary embodiment of the present disclosure.

FIG. 3B is a schematic cross-sectional side view along line X-X of the exemplary deformable membrane of FIG. 3A.

FIG. 3C is a schematic cross-sectional top view of an exemplary deformable membrane, through a plane of arrangement 150, according to one exemplary embodiment of the present disclosure.

FIG. 3D is a schematic cross-sectional side view along line Y-Y of the exemplary deformable membrane of FIG. 3C.

FIG. 3E is a schematic cross-sectional top view of an exemplary deformable membrane, through a plane of arrangement 150, according to one exemplary embodiment of the present disclosure.

FIG. 3F is a schematic cross-sectional side view along line W-W of the exemplary deformable membrane of FIG. 3E.

FIG. 4A is a schematic cross-sectional side view of an exemplary force-sensing capacitor element according to one exemplary embodiment of the present disclosure.

FIG. 4B is a schematic cross-sectional side view of an exemplary force-sensing capacitor element according to one exemplary embodiment of the present disclosure.

FIG. 5A is a schematic cross-sectional side view of an exemplary force-sensing capacitor element according to one exemplary embodiment of the present disclosure.

FIG. 5B is a schematic cross-sectional side view of an exemplary force-sensing capacitor element according to one exemplary embodiment of the present disclosure.

FIG. 5C is a schematic cross-sectional side view of the exemplary deformable membrane of FIG. 5A in compression, due to an applied force.

FIG. 5D is a schematic cross-sectional side view of the exemplary deformable membrane of FIG. 5B in compression, due to an applied force.

FIG. 6A is a schematic cross-sectional side view of an exemplary force-sensing capacitor element according to one exemplary embodiment of the present disclosure.

FIG. 6B is a schematic cross-sectional side view of an exemplary force-sensing capacitor element according to one exemplary embodiment of the present disclosure.

FIG. 6C is a schematic cross-sectional side view of the exemplary deformable membrane of FIG. 6A in compression, due to an applied force.

FIG. 6D is a schematic cross-sectional side view of the exemplary deformable membrane of FIG. 6B in compression, due to an applied force.

FIG. 7A is a schematic cross-sectional side view of an exemplary force-sensing capacitor element according to one exemplary embodiment of the present disclosure.

FIG. 7B is a schematic cross-sectional top view, through a plane of second electrode 720, of the exemplary force-sensing capacitor element of FIG. 7A.

FIG. 7C is a schematic cross-sectional side view of an exemplary force-sensing capacitor element according to one exemplary embodiment of the present disclosure.

FIG. 7D is schematic cross-sectional side view of the exemplary deformable membrane of FIG. 7C in compression, due to an applied force.

FIG. 8A is a schematic cross-sectional side view of an exemplary force-sensing capacitor element according to one exemplary embodiment of the present disclosure.

FIG. 8B is a schematic cross-sectional side view of the exemplary force-sensing capacitor element of FIG. 8A in compression, due to an applied force.

FIG. 9A is a schematic cross-sectional top view of an exemplary deformable membrane, through a plane of arrangement 150, according to one exemplary embodiment of the present disclosure.

FIG. 9B is a schematic cross-sectional side view along line Y-Y′ of the exemplary deformable membrane of FIG. 9A.

FIG. 10A is an optical photomicrograph of an exemplary deformable membrane according to one exemplary embodiment of the present disclosure.

FIG. 10B is an optical photomicrograph of an exemplary deformable membrane according to one exemplary embodiment of the present disclosure.

FIG. 10C is an optical photomicrograph of an exemplary deformable membrane according to one exemplary embodiment of the present disclosure.

FIG. 10D is an optical photomicrograph of an exemplary deformable membrane according to one exemplary embodiment of the present disclosure.

FIG. 11 is a plot of normalized capacitance versus applied load for force-sensing capacitors according to exemplary embodiments of the present disclosure.

FIG. 12A is an optical photomicrograph of a deformable membrane.

FIG. 12B is an optical photomicrograph of an exemplary deformable membrane according to one exemplary embodiment of the present disclosure.

FIG. 12C is an optical photomicrograph of an exemplary deformable membrane according to one exemplary embodiment of the present disclosure.

FIG. 12D is an optical photomicrograph of an exemplary deformable membrane according to one exemplary embodiment of the present disclosure.

FIG. 13 is an optical photomicrograph of an exemplary deformable membrane according to one exemplary embodiment of the present disclosure.

FIG. 14 is a plot of normalized capacitance versus applied load for force-sensing capacitors according to exemplary embodiments of the present disclosure.

Repeated use of reference characters in the specification and drawings is intended to represent the same or analogous features or elements of the disclosure. As used herein, the word “between”, as applied to numerical ranges, includes the endpoints of the ranges, unless otherwise specified. It should be understood that numerous other modifications and embodiments can be devised by those skilled in the art, which fall within the scope and spirit of the principles of the disclosure. The figures may not be drawn to scale.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

### DETAILED DESCRIPTION

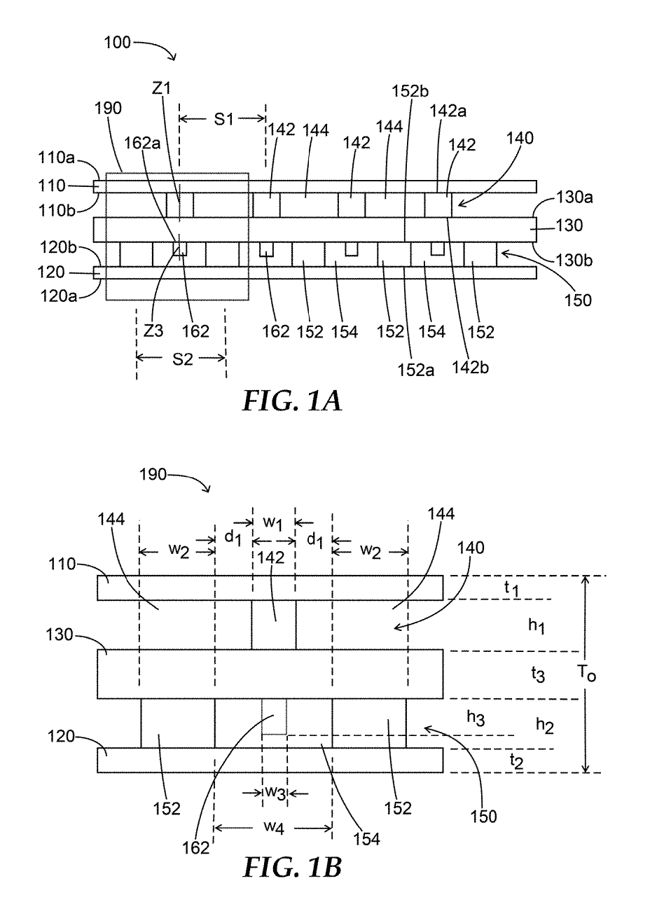

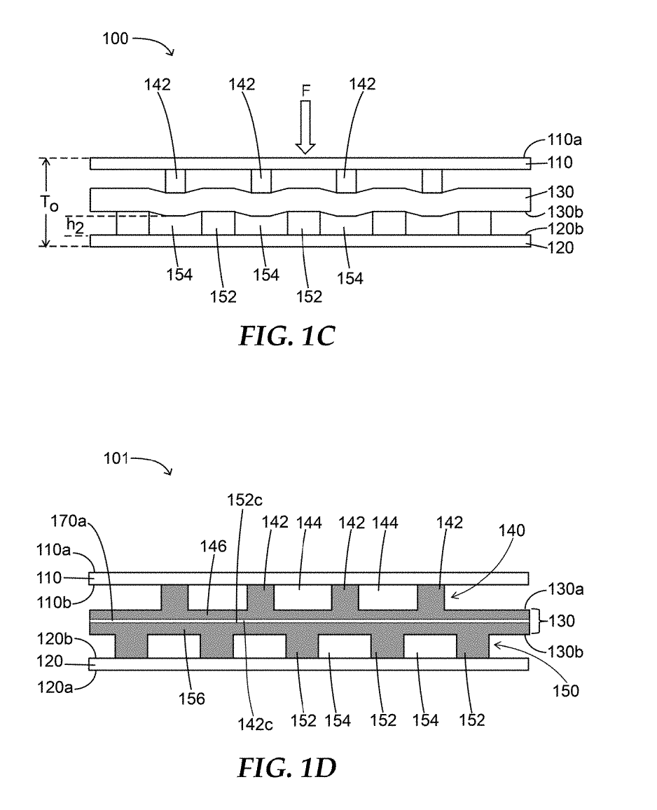

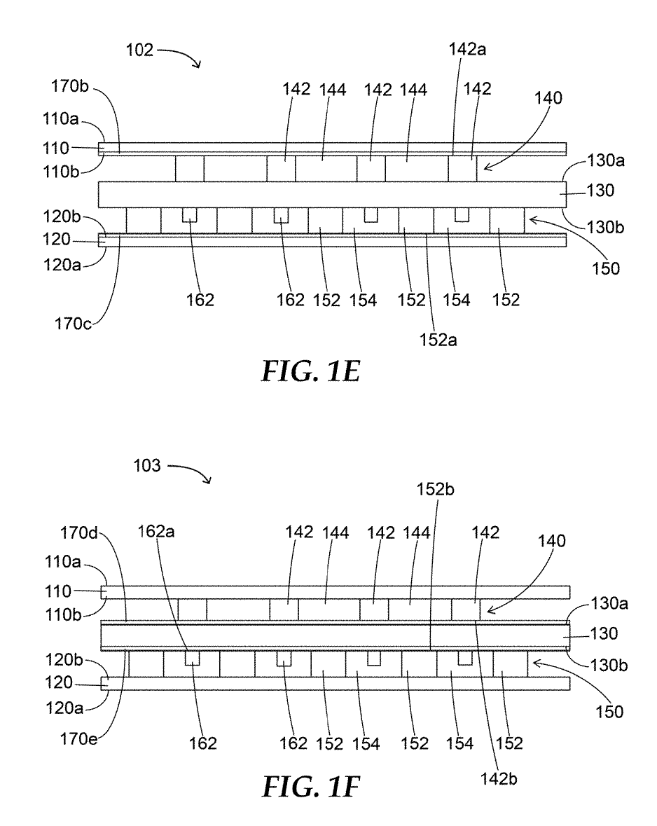

An embodiment of a deformable membrane, according to the present disclosure includes a first layer having first and second major surfaces; a second layer having first and second major surfaces; a third layer having first and second major surfaces interposed between the second major surface of the first layer and the second major surface of the second layer; a first arrangement comprising a plurality of first structures, with corresponding first void regions, interposed between the second major surface of the first layer and the first major surface of the third layer, wherein each first structure has a first surface facing or in contact with the second major surface of the first layer and a second surface facing or in contact with the first major surface of the third layer; and a second arrangement comprising one or more second structures, with corresponding second void regions, interposed between the second major surface of the second layer and the second major surface of the third layer, wherein each of the one or more second structures has a first surface facing or in contact with the second major surface of the second layer and a second surface facing or in contact with the second major surface of the third layer; and wherein each first surface of the first structures and each first surface of the one or more second structures are offset from one another such that there is no overlap between each first surface of the first structures and each first surface of the one or more second structures, through the thickness of the deformable membrane. Throughout this disclosure, if one surface is in contact with another surface, the two surfaces are, inherently, facing each other. Several specific, but non-limiting, embodiments are shown in FIGS. 1A-1F, FIG. 2 and FIGS. 3A-3F.

It is within the scope of the present disclosure, within deformable membranes or force-sensing capacitors comprising first structures and second structures wherein each first surface of the first structures and each first surface of the one or more second structures are offset from one another such that there is no overlap between each first surface of the first structures and each first surface of the one or more second structures, for there to be present a small proportion of first structures that are not offset from second structures, for example as might arise from defects in manufacturing.

Referring now to FIG. 1A, deformable membrane 100 includes a first layer 110 having first major surface 110a and second major surface 110b, a second layer 120 having first major surface 120a and second major 120b surface, a third layer 130 having first major surface 130a and second major surface 130b. Third layer 130 is interposed between the second major surface 110b of first layer 110 and second major surface 120b of second layer 120. Deformable membrane 100 further includes a first arrangement 140 comprising a plurality of first structures 142, with corresponding first void regions 144, interposed between second major surface 110b of first layer 110 and first major surface 130a of third layer 130. Each first structure 142 has a first surface 142a facing second major surface 110b of first layer 110, a second surface 142b facing first major surface 130a of third layer 130 and the first structures have corresponding imaginary axes, Z1, aligned perpendicular to and running through the centroids of their first surfaces 142a. For example, if first structures 142 are cylindrical in shape, with first surfaces 142a corresponding to one of the circular ends of the cylinder, imaginary axes Z1 would be perpendicular to and run through the center of the circular end of the cylinder. Deformable membrane 100 also includes a second arrangement 150 comprising one or more second structures 152, with corresponding second void regions 154, interposed between the second major surface 120b of the second layer 120 and the second major surface 130b of the third layer 130. Each of the one or more second structures has a first surface 152a in contact with the second major surface 120b of the second layer 120 and a second surface 152b in contact with the second major surface 130b of the third layer 130. The positional arrangement of the plurality of first structures 142 of the first arrangement 140, relative to the one or more second structures 152 of second arrangement 150, is defined such that each first surface 142a of the first structures 142 and each first surface 152a of the one or more second structures 152 are offset from one another such that there is no overlap between each first surface 142a of the first structures 142 and each first surface 152a of the one or more second structure 152, through the thickness of the deformable membrane. The pitch, S1, between neighboring first structures 142, i.e. the centroid to centroid distance between neighboring first structures 142 may be greater than about 10 microns, greater than about 50 microns, greater than about 100, microns, greater than about 200 microns, even greater than about 400 microns, less than about 5 cm, less than about 3 cm or even less than about 1 cm. Pitch S1 may be between about 10 microns and about 5 cm, between about 15 microns and about 1 cm, between about 20 microns and about 1 millimeter, between about 25 microns and 500 microns or even between about 50 microns and 300 microns. Pitch S2 may be greater than about 10 microns, greater than about 50 microns, greater than about 100, microns, greater than about 200 microns, even greater than about 400 microns, less than about 5 cm, less than about 3 cm or even less than about 1 cm. Pitch S2 may be between about 10 microns and about 5 cm, between about 15 microns and about 1 cm, between about 20 microns and about 1 millimeter, between about 25 microns and 500 microns or even between about 50 microns and 300 microns. First void regions 144 and second void regions 154 may include a fluid, i.e. a gas (air, for example) or a liquid.

Deformable membrane 100 may include, optionally, a plurality of third structures 162, having a first surface 162a proximate to or in contact with the second major surface 130b of the third layer 130 and imaginary axes, Z3, running perpendicular to and through the center of the centroid of first surfaces 162a. Throughout this disclosure, if a third structure is said to be proximate to a major surface of a layer, the third structure may be in contact with the major surface of the layer or one or more additional layers may be interposed between the third structure and major surface of the layer, with the third structure in contact with the surface of the adjacent additional layer. Third structures 162 are located in the void regions 154 of the second arrangement 150. In some embodiments, each third structure 162 aligns and overlaps, through the thickness of the deformable membrane 100, with a corresponding first structure 142 of the first arrangement 140. FIG. 1 shows a one to one correspondence between individual first structures 142 and individual third structures 162, however, a one to one correspondence is not required and there may be some first structures 142 that have no corresponding third structure 162. In some embodiments, at least some of the first structures 142 may correspond with one or more third structures 162 The individual first structures 142 and corresponding individual third structures 162 are shown in FIG. 1 to be completely overlapping, i.e. each first surfaces 162a of individual third structures 162 completely overlap with each second surfaces 142b of corresponding individual first structures 142, through the thickness of deformable membrane 100. In some embodiments, there may be only partial overlap between individual third structures 162 and corresponding individual first structures 142, through the thickness of deformable membrane 100. The individual first structures 142 and corresponding individual third structures 162 are shown in FIG. 1 to be in alignment, i.e. imaginary axes Z3 align with imaginary axes, Z1, through the thickness of the deformable membrane 100. In some embodiments, at least some of the third structures 162 and corresponding first structures 142 may be offset, e.g. imaginary axes Z3 do not align with corresponding imaginary axes Z1, through the thickness of the deformable membrane 100. The size of the third structures 162 may be selected such that one or more of third structures 162 are not in contact with the second major surface 120b of second layer 120.

FIG. 1B shows cut-out 190 of FIG. 1A in more detail, including first layer 110, second layer 120, third layer 130, first structure 142 and void regions 144 of first arrangement 140, one or more second structures 152 and void region 154 of second arrangement 150 and third structure 162. The thicknesses tᵢ, heights hᵢ and widths wᵢ of various elements included in deformable membrane 100 are shown. First layer 110, second layer 120 and third layer 130 have thickness t₁, t₂ and t₃, respectively. The deformable membranes of the present disclosure are not particularly limited with respect to thicknesses t₁, t₂ and t₃, although some thicknesses t₁, t₂ and t₃ may be particularly advantageous. The thicknesses t₁, t₂ and t₃ may each be greater than about 5 microns, greater than about 10 microns, greater than about 20 microns, greater than about 30 microns, greater than about 40 microns or even greater than about 50 microns; less than about 250, less than about 225 microns, less than about 200 microns, less than about 175 microns, or even less than 150 microns. Thicknesses t₁, t₂ and t₃ may each be between about 5 microns and about 250 microns, between about 10 microns and 200 microns, between about 15 microns and about 140 microns, about 20 microns and about 130 microns or even between about 25 microns and 100 about microns. The total thickness of the deformable membrane 100 is represented by Tₒ. Tₒ varies depending on the selection of t₁, t₂, t₃, h₁ and h₂. In some embodiments, Tₒ is between about 50 microns and about 2 mm, in some embodiments between about 100 microns and about 1 mm, in some embodiments between about 150 microns and about 550 microns, and in some embodiments between about 200 microns and about 500 microns.

First layer 110, second layer 120 and third layer 130 may be fabricated from materials having a Young's modulus over a broad range. First layer 110, second layer 120 and third layer 130 may have a Young's modulus between, for example, about 0.1 MPa and about 100 GPa. The selection of the Young's modulus of each layer is based on the end-use application requirements for the deformable membrane 100 which will subsequently dictate the design criteria for the deformable membrane 100. In some embodiments, the Young's modulus of one or more of first layer 110, second layer 120 and third layer 130 may be required to be relatively high, providing a relatively stiff layer (e.g., a glass layer with Young's modulus of between about 50 GPa and about 100 GPa). In these embodiments, the Young's modulus of one or more of first layer 110, second layer 120 and third layer 130 may be greater than about 0.05 GPa, greater than about 0.1 GPa or even greater than about 1 GPa; less than about 100 GPa, less than about 10 GPa or even less than about 5 GPa. The Young's modulus may be between about 0.05 GPa and about 10 GPa, between about 0.1 GPa and about 10 GPa, between about 1 GPa and 10 GPa or even between about 1 GPa and about 5 GPa. In other embodiments, the Young's modulus of one or more of first layer 110, second layer 120 and third layer 130 may be required to be relatively low, providing a relatively flexible layer (e.g., an elastomer, for example a silicone elastomer, with Young's modulus of between 0.5 and 5 MPa). In these embodiments, the Young's modulus of one or more of first layer 110, second layer 120 and third layer 130 may be greater than about 0.1 MPa, greater than about 1.0 MPa, greater than about 2.0 MPa, greater than about 5.0 MPa or even greater than about 10 MPa; less than about 50 MPa, less than about 40 MPa or even less than about 30 MPa. The Young's modulus may be between about 0.1 MPa and about 0.05 GPa, between about 1 MPa and about 40 MPa, between about 2 MPa and about 30 MPa or even between about 3 MPa and about 25 MPa. In some embodiments, the Young's modulus of the third layer is less than at least one of the Young's modulus of the first layer and second layer.

First layer 110, second layer 120 and third layer 130 may be dielectric materials, e.g. may include ceramic and polymeric materials (thermoplastics, thermoplastic elastomers and thermosets, including glassy thermosets and elastomeric thermosets, i.e. rubbers, and foams, including foamed rubbers). Suitable ceramic materials include, but are not limited to, glass, titanium dioxide, barium titanate, tantalum pentoxide, sapphire and the like. Suitable polymeric materials include, but are not limited to, polyesters (e.g. polyethylene terephtahlate and polyethylene naphthalate), polycarbonates, polyimides, polyamides (e.g. Nylon 6,6), polyalkylenes (e.g. polyethylene and polypropylene), polyether sulphones, polyether ether ketones (PEEKs), polyarylene ether nitriles (PENs), polyacrylates (e.g. acrylics), polystyrene, fluoropolymers (e.g. fluoroplastics and fluoroelastomers), and rubbers (e.g. silicone, EPDM, neoprene, isoprene, natural rubber and the like). Two or more of first layer 110, second layer 120 and third layer 130 may include the same material, i.e. may be fabricated from the same material. In some embodiments all three layers include the same material. In other embodiments, each of the first layer, the second layer and the third layer may be different materials. Each of first layer 110, second layer 120 and third layer 130 may include multiple materials in the form of a blend or composite of materials or a laminate. A laminate is defined as two or more sheets of material coupled together to form a single structure. In some embodiments, one or more of first layer 110, second layer 120 and third layer 130 are not laminates.

In some embodiments of the force-sensing capacitors, one or more of the first layer 110, the second layer 120, and the third layer 130 are metals (also referred to herein as being metallic), for example composed of metal (metallic material). For example, in some embodiments the first layer and the second layer are metals. In other embodiments, the second layer and the third layer are metals. In yet other embodiments, the first layer, the second layer, and the third layer are metals. Examples of useful metals include elemental metals, metal alloys, and intermetallics, including but not limited to copper, silver, stainless steel, spring steel, tool steel, brass, nickel, aluminum, titanium, nickel titanium alloy (e.g., Nitinol). In the present disclosure a layer that is described to be a metal may comprise regions (e.g., layers) of different metals (i.e., different metal compositions).

First structures 142 and one or more second structures 152 have heights, h₁ and h₂, respectively. The deformable membranes of the present disclosure are not particularly limited with respect to heights, h₁ and h₂, although some heights, h₁ and h₂, may be particularly advantageous. The heights h₁ and h₂ may each be greater than about 5 microns, greater than about 10 microns, greater than about 20 microns, greater than about 30 microns, greater than about 40 microns, greater than about 50 microns, greater than about 100 microns, greater than about 250 microns, greater than about 500 microns; less than about 1 millimeter, less than about 500 microns, less than about 250 microns, less than about 175 microns, or even less than 150 microns. Each of the heights h₁ and h₂ may be between about 5 microns and about 1 mm, between about 10 microns and about 500 microns between about 15 microns and about 250 microns, between about 25 microns and about 150 microns, between about 40 microns and about 125 microns, between about 45 microns and about 110 microns or even between about 50 microns and about 100 microns. The heights h₁, of first structures 142 may all be the same, within the normal tolerances of their manufacturing process. In these embodiments, first layer 110 and third layer 130 are substantially parallel to one another. The heights h₁, may vary, with the heights h₁ of each individual first structure 142 being within about 30%, about 20%, about 10% or even about 5% of the average value of all heights h₁. In embodiments where the heights, h₁ taper systematically across an area of the deformable membrane, the variation in heights h₁ may cause a variation in the distance between first layer 110 and third layer 130 and the two layers may not be substantially parallel to one another, and first layer 110 and second layer 120 may also not be substantially parallel to one another. The heights h₂, of one or more second structures 152 may all be the same, within the normal tolerances of their manufacturing process. In these embodiments, second layer 120 and third layer 130 are substantially parallel to one another. The heights h₂, may vary, with the heights h₂ of each individual second structure 152 being within about 30%, about 20%, about 10% or even about 5% of the average value of all heights h₂. In embodiments where the heights, h₂ taper systematically across an area of the deformable membrane, the variation in heights h₂ may cause a variation in the distance between second layer 120 and third layer 130 and the two layers may not be substantially parallel to one another, and second layer 120 and first layer 110 may also not be substantially parallel to one another. In some embodiments, first layer 110, second layer 120 and third layer 130 may be substantially parallel to one another. First layer 110 may be substantially parallel to second layer 120. First layer 100 may be substantially parallel to third layer 130. Second layer 120 may be substantially parallel to third layer 130.

First structures 142 have a widths w₁. The deformable membranes of the present disclosure are not particularly limited with respect to widths w₁, although some widths w₁ may be particularly advantageous. The widths w₁ may be greater than about 5 microns, greater than about 10 microns, greater than about 20 microns, greater than about 30 microns, greater than about 40 microns or even greater than about 50 microns; less than about 5 mm, less than about 1 mm, less than about 0.5 mm, or even less than about 0.25 mm. The widths w₁ may be between about 5 microns and about 5 mm, between about 10 microns and about 1 mm, between about 10 microns and about 1 mm, between about 20 microns and about 0.5 mm, between about 30 microns and about 0.25 mm or even between about 40 microns and about 200 microns. The widths w₁ of first structures 142 may all be the same, within the normal tolerances of their manufacturing process, or may vary within the size range described above. One or more second structures 152 have a widths w₂. The widths w₂ may be greater than about 5 microns, greater than about 10 microns, greater than about 20 microns, greater than about 30 microns, greater than about 40 microns or even greater than about 50 microns; less than about 10 mm, less than about 5 mm, less than about 1 mm, less than about 0.5 mm, or even less than about 0.25 mm. The widths w₂ may be between about 5 microns and 10 mm, between about 10 microns and about 1 mm, between about 20 microns and about 0.5 mm, between about 30 microns and about 0.25 mm or even between about 40 microns and about 200 microns. The widths w₂ of one or more second structures 152 may all be the same, within the normal tolerances of their manufacturing process, or may vary within the size range described above. Second void regions 154 have widths w₄. The widths w₄ may be greater than about 20 microns, greater than about 50 microns, greater than about 100 microns, greater than about 200 microns, greater than about 300 microns or even greater than about 400 microns; less than about 20 mm, less than about 15 mm, less than about 10 mm, less than about 5 mm, or even less than about 1 mm. The widths w₄ may be between about 20 microns and about 20 mm, between about 10 microns and about 1 mm, between about 20 microns and about 0.5 mm, between about 30 microns and about 0.25 mm or even between about 40 microns and about 200 microns. The widths w₄ may all be the same, within the normal tolerances of their manufacturing process, or may vary within the size range described above.

The lengths, L₁, of first structures 142 and the lengths, L₂, of one or more second structures 152 (neither shown in FIG. 1) are not particularly limited. Lengths L₁ of first structures 142 and lengths L₂ of one or more second structures 152 may span the entire length of deformable membrane 100. In some embodiments, lengths L₁ may be greater than about 5 microns, greater than about 10 microns, greater than about 20 microns, greater than about 30 microns, greater than about 40 microns, greater than about 50 microns, greater than about 1 millimeter, greater than about 1 centimeter, or even greater than about 10 centimeters; less than about 5 mm, less than about 1 mm, less than about 0.5 mm, or even less than about 0.25 mm. The lengths L₁ may be between 5 microns and about 10 cm, between about 10 microns and about 10 cm, between about 20 microns and about 1 cm, between about 30 microns and about 1 mm or even between about 40 microns and about 500 microns. In some embodiments, lengths L₂ may be greater than about 5 microns, greater than about 10 microns, greater than about 20 microns, greater than about 30 microns, greater than about 40 microns, greater than about 50 microns, greater than about 1 millimeter, greater than about 1 centimeter, or even greater than about 10 centimeters; less than about 10 mm, less than about 5 mm, less than about 1 mm, less than about 0.5 mm, or even less than about 0.25. The lengths L₂ may be between 5 microns and about 10 cm, between about 10 microns and about 10 cm, between about 20 microns and about 1 cm, in some embodiments between about 30 microns and about 1 mm or even between about 40 microns and about 500 microns.

At least some of first structures 142 of first arrangement 140 and at least some of one or more second structures 152 of second arrangement 150 may be isolated discrete structures, i.e. no portion of an individual structure is connected to another portion of a different individual structure as shown in FIG. 1A, fabricated by, for example, a three-dimensional printing process. At least some of first structures 142 of first arrangement 140 and at least some of one or more second structures 152 of second arrangement 150 may be connected discrete structures, i.e. discrete structures connected by a land region having a height at least about 75% less than, at least about 50% less than, at least about 25% less than, at least about 10% less than or even at least about 5% less than the height of the structure, fabricated by, for example, an embossing or micro-replication process. In some embodiments, a planar film encompassing the land region and corresponding portions of at least one of the of first structures 142 of first arrangement 140 and at least some of one or more second structures 152 of second arrangement 150 may be the third layer. FIG. 1D shows deformable membrane 101 having the identical construction to deformable membrane 100, except for the following modifications. Deformable membrane 101 does not include optional third structures 162. Deformable membrane 101 includes arrangement 140 with connected discrete first structures 142, void regions 144, backside surface 142c and corresponding land regions 146 and second arrangement 150 includes connected discrete second structures 152, void regions 154, backside surface 152c and corresponding land regions 156. Adhesive layer 170a adheres backside surface 142c to backside surface 152c. Third layer 130 is subsequently formed from both the planar film encompassing the land regions 146 and corresponding portions of structures 142, the land regions 156 and corresponding portions of structures 152 and adhesive layer 170a. Combinations of isolated discrete structures and connected discrete structures may be used for both first arrangement 140 and second arrangement 150. If one or both of first arrangement 140 and second arrangement 150 include a land region, connecting at least some individual structures within the given arrangement, the surface area of the land region between the structures is not included in defining first surfaces 142a and second surfaces 142b of first structures 142 and is not included in defining first surfaces 152a and second surfaces 152b of one or more second structures 152. In some embodiments, the first structures of the first arrangement, second structures of the second arrangement and the third layer may be a unitary body. In other embodiments, the first structures of the first arrangement and the first layer may be a unitary body. In yet other embodiments, the second structures of the second arrangement and the second layer may be a unitary body

The number of first structures 142 of first arrangement 140 and one or more second structures 152 of second arrangement 150 are not particularly limited and may be selected based on the end use requirements. As the deformable membranes may be used in force-sensing capacitor elements, useful in, for example a touch screen display, the resolution requirements of the touch screen display may dictate the resolution requirements of the force-sensing capacitor element and subsequently the design, e.g. number of first and second structures, the pattern of first and second structures and the size of the first and second structures. The areal density of first structures 142 and one or more second structures 152 may each be greater than about 0.04 structures/cm², greater than about 1 structures/cm², greater than about 10 structures/cm², greater than about 100 structures/cm² or even greater than about 1,000/cm² structures; less than about 1,000,000 structures/cm², less than about 500,000 structures/cm², less than about 100,000 structures/cm², less than about 50,000 structures/cm² or even less than about 10,000 structures/cm².

Referring back to FIG. 1B, the lateral distances d₁ represents the distance between an edge of first structure 142 and the edge of an adjacent one or more second structure 152. The deformable membranes of the present disclosure are not particularly limited with respect to the lateral distances d₁, although some lateral distances d₁ may be particularly advantageous. The distances d₁ may be greater than about 0 microns, greater than about 5 microns, greater than about 10 microns, greater than about 20 microns, greater than about 30 microns, greater than about 40 microns or even greater than about 50 microns; less than about 5 mm, less than about 1 mm, less than about 0.5 mm, or even less than 0.25 mm. The distance d₁ may be between about 5 microns and about 5 millimeters, between about 10 microns and 1 mm, between about 20 microns and about 0.5 mm, between about 30 microns and about 250 microns, between about 40 microns and about 225 microns, between about 50 microns and about 200 microns or even between about 60 microns and about 190 microns. The distances d₁ may all be the same between all adjacent structures, within the normal tolerances of the manufacturing process used to fabricate the deformable membrane 100. For example, if first arrangement 140 includes identical, first structures 142 configured in a square grid array and second arrangement 150 includes identical, one or more second structures 152 configured in an identical sized square grid array and the two arrangements are offset such that the centers of the first structures 142 of first arrangement 140 lie at the center points of the squares of the square grid array formed by one or more second structures 152 of second arrangement 150, distance d₁ will be the same for all adjacent first structures 142 and one or more second structures 152. In some embodiments, distances d₁ will vary between adjacent structures. Distances d₁ will be determined by the pattern of first structures 142 of arrangement 140 and the pattern of one or more second structures 152 of arrangement 150, as well as the corresponding size and shape of the structures.

The shape of first structures 142 and one or more second structures 152 are not particularly limited. The shape of first structures 142 and second structures 152 include, but are not limited to, cubic, cylindrical, prismatic, rectangular, hexagonal, octagonal, pyramidal, truncated pyramidal, conical, truncated conical, ellipsoidal, spheroidal, hemispherical and combinations thereof. The shape of first structures 142 and one or more second structures 152 may be parallelepiped, e.g. rectangular parallelpiped. First surface 142a and second surface 142b of first structures 142 and first surface 152a and second surface 152b of one or more second structures 152 may have shapes that include, but are not limited to, flat, pointed, faceted and rounded.

First structures 142 and one or more second structures 152 may be dielectric materials, e.g. ceramic and polymeric materials (thermoplastics, thermoplastic elastomers and thermosets, including glassy thermosets and elastomeric thermosets, i.e rubbers). Suitable ceramic materials and polymeric materials include, but are not limited to, those described for first layer 110, second layer 120 and third layer 130.

First structures 142 and second structures 152 may be fabricated from materials having a Young's modulus over a broad range. First structures 142 and second structures 152 may have a Young's modulus between about 0.1 MPa and about 10 GPa. The selection of the Young's modulus of first structures 142 and second structures 152 is based on the end-use application requirements for the deformable membrane 100 which will subsequently dictate the design criteria for the deformable membrane 100. In some embodiments, the Young's modulus of one or more of first structures 142 and second structures 152 may be required to be relatively high, providing a relatively stiff layer. In these embodiments, the Young's modulus of one or more of first structures 142 and second structures 152 may be greater than about 0.05 GPa, greater than about 0.1 GPa or even greater than about 1 GPa; less than about 10 GPa, less than about 7.5 GPa or even less than about 5 GPa. The Young's modulus may be between about 0.05 GPa and about 10 GPa, between about 0.1 GPa and about 10 GPa, between about 1 GPa and 10 GPa or even between about 1 GPa and about 5 GPa. In other embodiments, the Young's modulus of one or more of first structures 142 and second structures 152 may be required to be relatively low, providing a relatively flexible layer. In these embodiments, the Young's modulus of one or more of first structures 142 and second structures 152 may be greater than about 0.1 MPa, greater than about 1.0 MPa, greater than about 2.0 MPa, greater than about 5.0 MPa or even greater than about 10 MPa; less than about 50 MPa, less than about 40 MPa or even less than about 30 MPa. The Young's modulus may be between about 0.1 MPa and about 0.05 GPa, between about 1 MPa and about 40 MPa, between about 2 MPa and about 30 MPa or even between about 5 MPa and about 25 MPa. In some embodiments, the Young's modulus of the first structures 142, the second structures 152 and the third layer 130 are the same and first structures 142, second structures 152 and the third layer 130 are a unitary body, formed by, for example, injection molding of a polymer.

First arrangement 140 and second arrangement 150 may include various patterns of first structures 142 and one or more second structures 152, respectively. The patterns are not particularly limited and may include a random pattern of the structures, a non-random pattern of the structures and combinations thereof. The patterns may be linear, e.g. a line of first structures and a line of one or more second structure, or may be two-dimensional, e.g. a two-dimensional array of first structures and a two-dimensional array of one or more second structures. In some embodiments, at least one of first arrangement 140 and second arrangement 150 include a pattern of first structures 142 and one or more second structures 152, respectively, that include but are not limited to, square grid array pattern, rectangular grid array pattern, hexagonal grid array pattern, a set of parallel lines, a set of curved parallel lines, two sets of parallel lines, wherein one first set of parallel lines cross the second set of parallel lines at an included angle theta, wherein the smallest included angle, theta, between the first set of parallel lines and the second set of parallel lines may be between about 5° and about 90°, between about 30° and about 90° or even between about 50° and about 90°. Combinations of patterns may be used in different areas of each arrangement. First arrangement 140 and second arrangement 150 may include the same pattern or differing patterns. Second arrangement 150 may include only one structure 152 that includes at least two or more second void regions 154. At least some of the second void regions 154 will align, through the thickness of the deformable membrane, to the position of first structures 142. In some embodiments, one or both of first arrangement 140 and second arrangement 150 include void regions 144 and second void region 154, respectively, that enables a fluid, i.e. a gas or liquid, to flow out from any area of respective first arrangement 140 and second arrangement 150.

In some embodiments, the size and shape of first structures 142 and one or more second structures 152, as well as, the patterns of the structures of arrangements 140 and 150 are selected, such that, each first surface 142a of the first structures 142 and each first surface 152a of one or more second structures 152 are offset from one another such that there is no overlap between each first surface 142a of the first structures 142 and each first surface 152a of the one or more second structures 150, through the thickness of the deformable membrane.

Optional third structures 162 have widths w₃. The deformable membranes of the present disclosure are not particularly limited with respect to the widths w₃, although some widths w₃ may be particularly advantageous. The widths w₃ may be greater than about 5 microns, greater than about 10 microns, greater than about 20 microns, greater than about 30 microns, greater than about 40 microns or even greater than about 50 microns; less than about 5 mm, less than about 3, less than about 1 mm, less than about 0.5 mm, or even less than 0.25 mm. The widths w₃ may be between about 5 microns and about 5 mm, between about 10 microns and about 3 mm, between about 20 microns and 1 mm, between about 30 microns and 0.5 mm or even between about 40 microns and 25 mm. The widths w₃ of third structures 162 may all be the same, within the normal tolerances of their manufacturing process, or may vary within the size range described above. Third structures 162 have heights h₃. The deformable membranes of the present disclosure are not particularly limited with respect to the heights h₃, although some heights h₃ may be particularly advantageous. The heights h₃ may be greater than about 5 microns, greater than 10 microns, greater than 20 microns, greater than 30 microns, greater than 40 microns or even greater than 50 microns; less than about 240, less than about 225 microns, less than about 200 microns, less than about 175 microns, or even less than 150 microns. The heights h₃ may be between about 5 microns and about 240 microns, between about 10 microns and about 200 microns, between about 15 microns and about 175 microns, between about 25 microns and about 150 microns, between about 40 microns and about 125 microns, between about 45 microns and about 110 microns or even between about 50 microns and about 100 microns. Heights h₃ of third structures 162 may all be the same, within the normal tolerances of their manufacturing process. Heights h₃ may vary, with the heights h₃ of each individual first structure 162 being within about 20%, about 10% or even about 5% of the average value of all heights h₃. The lengths of third structures 162, L₃, (not shown in FIG. 1) are not particularly limited. Lengths L₃ of third structures 162 may span the entire length of deformable membrane 100. In some embodiments, lengths L₃ may be greater than about 5 microns, greater than about 10 microns, greater than about 20 microns, greater than about 30 microns, greater than about 40 microns or even greater than about 50 microns; less than about 5 mm, less than about 1 mm, less than about 0.5 mm, or even less than about 0.25 mm. The lengths L₃ may be between about 5 microns and about 10 cm, between about 10 microns and about 10 centimeters, between about 20 microns and about 1 cm, between about 30 microns and about 1 mm or even between about 40 microns and about 500 microns.

The number of third structures 162 of first arrangement 160 in deformable membrane 100 is not particularly limited and may be selected based on the end use requirements. The number of third structures 162 may be the same or less than the number of first structures 142 of first arrangement 140. The areal density of third structures 162 may be greater than about 0.04 structures/cm², greater than about 1 structures/cm², greater than about 10 structures/cm², greater than about 100 structures/cm² or even greater than about 1,000/cm² structures; less than about 1,000,000 structures/cm², less than about 500,000 structures/cm², less than about 100,000 structures/cm², less than about 50,000 structures/cm² or even less than about 10,000 structures/cm².

In some embodiments, at least one of the dimensions w₃, h₃ and L₃ of at least some of third structures 162 is less than the corresponding dimensions, w₁, h₁ and L₁, of corresponding first structures 142. In other embodiments, all three dimensions w₃, h₃ and L₃ of at least some of third structures 162 are less than the corresponding dimensions w₁, h₁ and L₁ of corresponding first structures 142. In some embodiments, at least some of heights h₃ of third structures 162 are less than heights h₂ of adjacent second structures 152 and the distal end of third structure 162 does not contact second surface 120b of second layer 120. The shape of third structures 162 and the shape of their surfaces are not particularly limited and include, but are not limited to, the shapes described for first structures 142 and one or more second structures 152. The patterns of third structures 162 are not particularly limited and include, but are not limited to, the patterns described for first structures 142 and one or more second structures 152.

The third structures may be dielectric materials, e.g. ceramic and polymeric materials and may include the same ceramic and polymeric materials described for the first, second and third layers. The third structures may include electrically conductive materials. The third structures may be composites, e.g. a polymer matrix composite including a polymeric matrix and, at least one of, electrically conductive particles, fibers, woven or non-woven mats and the like. The electrically conductive particles, fibers, woven or non-woven mats and the like may include metals, including but are not limited to, aluminum, copper, silver and gold. They also may be non-electrically conductive particles, fibers, woven or non-woven mats that have been coated with a conductive material, e.g. a metal, including but not limited to, aluminum, copper, silver and gold.

During use, in for example, a force-sensing capacitor element, a force F is applied to the first major surface 110a of first layer 110 of deformable membrane 100, FIG. 1C. The force F is applied over a finite, nonzero area A. Force F applied uniformly over an area A results in an applied uniaxial pressure (also referred to herein as compressive stress) P=F/A. In some embodiments of the present disclosure, where an applied force is depicted in the corresponding figures, the force is taken to be uniformly applied over the surface proximate to the force vector. Force F compresses deformable membrane 100, causing the total thickness Tₒ to decrease. Force F also urges structures 142 into third layer 130 causing third layer 130 to deflect into void regions 154, while second structures 152 provide support for third layer 130. In void regions 154 where third layer 130 has deflected, the distance h₂ between second major surface 130b and second major surface 120b is decreased. The change in distances ΔTₒ (Tₒ before applying force F-Tₒ after applying force F) and Δh₂ (h₂ before applying force F-h₂ after applying force F) of deformable membrane 100 may be a controlled dependence with respect to the applied force F. In some embodiments, the change in distances ΔTₒ and Δh₂ of deformable membrane 100 in response to an applied force F may be proportional to the applied force F. The controlled dependence between applied Force F and the compression of the deformable membrane 100, i.e. the change in distance ΔTₒ and Δh₂, can be determined, for example, by experimental modeling, e.g. finite element modeling. As will be discussed in more detail, if appropriate electrodes are positioned near void regions 154, forming a capacitor, the capacitance will change as the distances Tₒ and h₂ change in response to the applied force F.

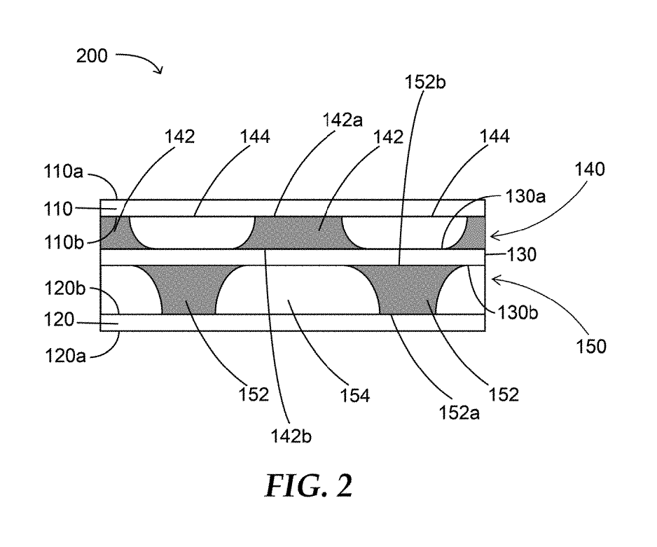

Another embodiment of a deformable membrane, according to the present disclosure, is shown in FIG. 2. Referring now to FIG. 2, deformable membrane 200 includes a first layer 110 having first major surface 110a and second major surface 110b, a second layer 120 having first major surface 120a and second major 120b surface, a third layer 130 having first major surface 130a and second major surface 130b. Third layer 130 is interposed between the second major surface 110b of the first layer 110 and the second major surface 120b of the second layer 120. Deformable membrane 200 further includes a first arrangement 140 comprising a plurality of first structures 142, with corresponding first void regions 144, interposed between the second major surface 110b of the first layer 110 and the first major surface 130a of the third layer 130. Each first structure 142 has a first surface 142a in contact with the second major surface 110b of the first layer 110, a second surface 142b in contact with the first major surface 130a of the third layer 130. Deformable membrane 200 also includes a second arrangement 150 comprising one or more second structures 152, with corresponding second void regions 154, interposed between the second major surface 120b of the second layer 120 and the second major surface 130b of the third layer 130. Each of the one or more second structures has a first surface 152a in contact with the second major surface 120b of the second layer 120 and a second surface 152b in contact with the second major surface 130b of the third layer 130. First structures 142 and second structures 152 are each shown to be tapered, with the widths of surfaces 142a and 152a being less than the widths of surfaces 142b and 152b, respectively. Although, second surfaces 142b of first structures 142 partially overlap with second surfaces 152b of one or more second structures 152, through the thickness of the deformable membrane, first surfaces 142a and first surfaces 152a do not overlap, though the thickness of deformable membrane 200. Thus, structures 142 are offset from structures 152.

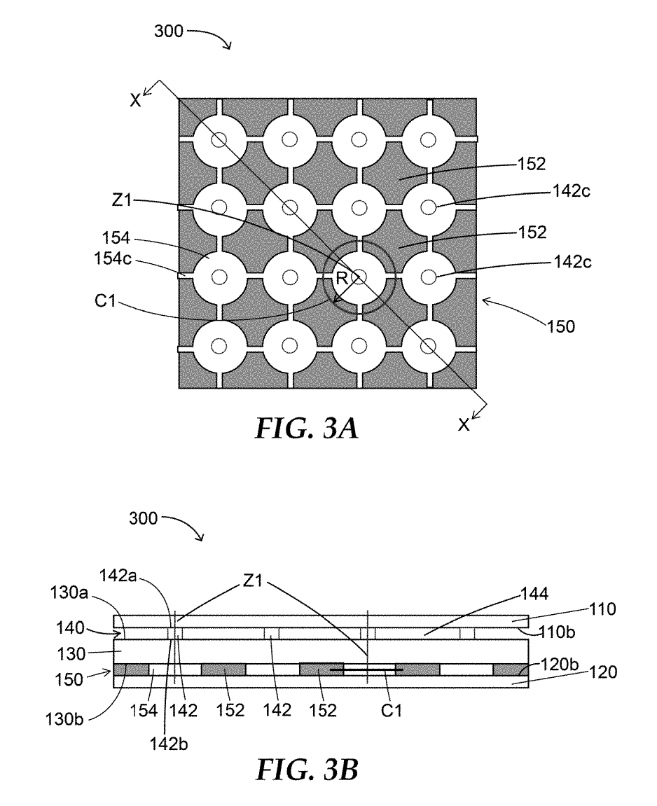

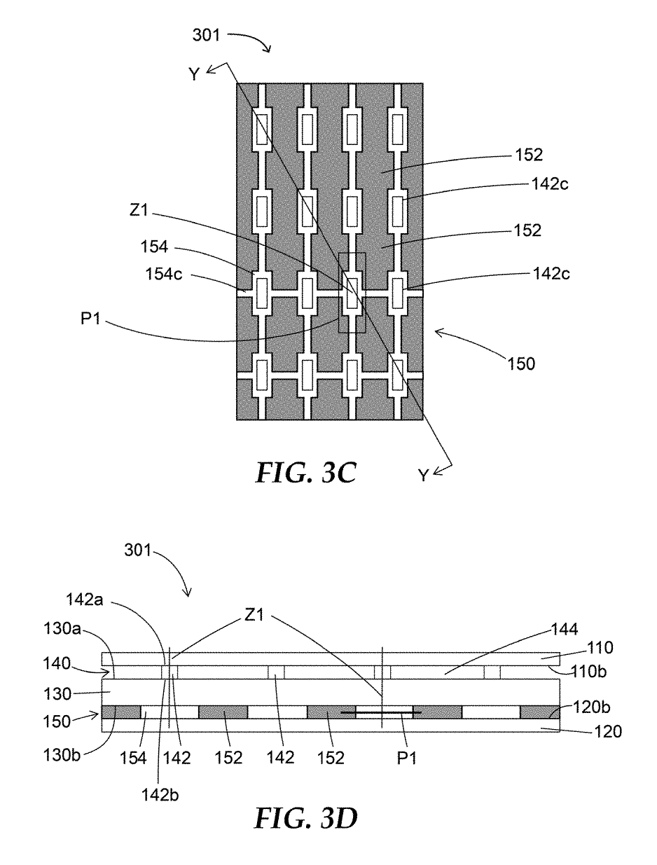

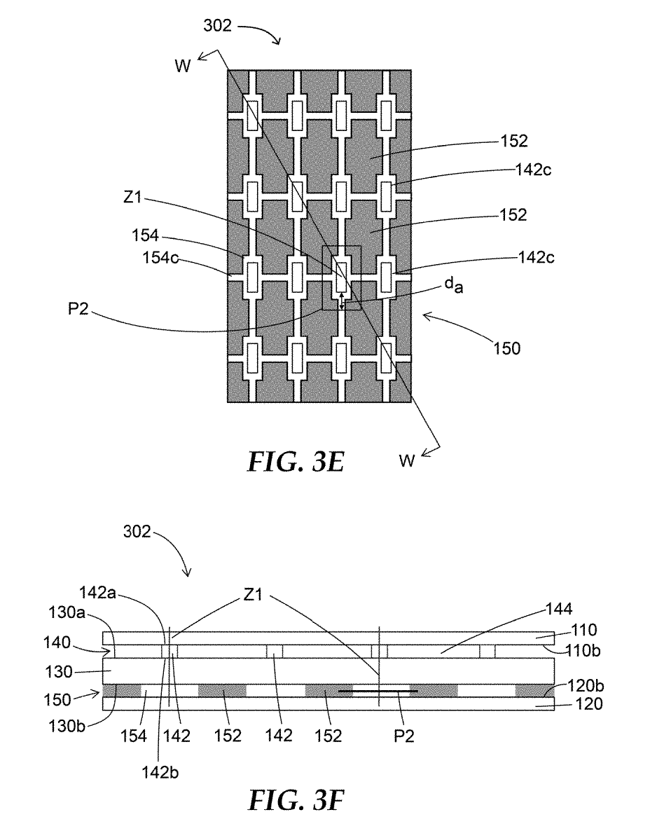

Yet another embodiment of a deformable membrane, according to the present disclosure, is shown in FIGS. 3A and 3B. FIG. 3A is a schematic cross-sectional top view of a plane running through and parallel to second arrangement 150 of deformable membrane 300 while FIG. 3B is the corresponding schematic cross-sectional side view of deformable membrane 300 along line X-X of FIG. 3A. FIGS. 3A and 3B show deformable membrane 300 which includes first layer 110 having second major surface 110b, second layer 120 having second major surface 120b, third layer 130 with first major surface 130a and second major surface 130b. Third layer 130 is interposed between the second major surface 110b of the first layer 110 and the second major surface 120b of the second layer 120. Deformable membrane 300 further includes a first arrangement 140 comprising a plurality of first structures 142, with corresponding first void regions 144, interposed between the second major surface 110b of the first layer 110 and first major surface 130a of third layer 130. Each first structure 142 has a first surface 142a facing the second major surface 110b of the first layer 110, a second surface 142b facing the first major surface 130a of the third layer 130 and an imaginary axis, Z1, aligned perpendicular to and through the centroid of first surfaces 142a. In FIG. 3A, projections of first surfaces 142a of first structures 142 onto the plane of arrangement 150 are represented by the small, dashed circles 142c. Deformable membrane 300 includes a second arrangement 150 comprising a plurality of second structures 152, with corresponding first void regions 154, interposed between second major surface 120b of second layer 110 and second major surface 130b of third layer 130. The plurality of second structures 152 substantially surround each of the first structures 142. In some embodiments, void regions 154 include channels 154c that allow a fluid, e.g. a gas, such as air, to flow through and out of arrangement 150. An arbitrary, imaginary circle, C1, having an arbitrary radius R is shown. Circle C1 intersects four second structures 152, in this embodiment. The circumference (also referred to herein as the perimeter) of circle C1 intersects the four structures 152 along about 90% of the circumference length. The surface of arbitrary circle C1 may be perpendicular to the imaginary axis Z1 of first structures 142.

In some embodiments of deformable membranes of the present disclosure, the first structures of the first arrangement have corresponding imaginary axes, Z1, aligned perpendicular to and running through the centroids of their first surfaces, at least one of the imaginary axes Z1, at least about 25% of the imaginary axes Z1, at least about 50% of the imaginary axes Z1, at least about 75% of the imaginary axes Z1, at least about 90% of the imaginary axes Z1 or even all the imaginary axes Z1, of the first structures of the first arrangement is surrounded by the one or more second structures of the second arrangement such that an imaginary circle C1 in a region of the second arrangement, having a radius R drawn around the at least one of the imaginary axes, intersects the at least one or more second structures of the second arrangement along at least about 50% of the circumference length, along at least about 55% of the circumference length, along at least about 60% of the circumference length, along at least about 65% of the circumference length, along at least about 70% of the circumference length, along at least about 75% of the circumference length, along at least about 80% of the circumference length, along at least about 85% of the circumference length, along at least about 90% of the circumference length, along at least about 95% of the circumference length, or even 100% of the circumference length.

Yet another embodiment of a deformable membrane, according to the present disclosure, is shown in FIGS. 3C and 3D. FIG. 3C is a schematic cross-sectional top view of a plane running through and parallel to second arrangement 150 of deformable membrane 301 while FIG. 3D is the corresponding schematic cross-sectional side view of deformable membrane 301 along line Y-Y of FIG. 3C. FIGS. 3C and 3D show deformable membrane 301 which includes first layer 110 having second major surface 110b, second layer 120 having second major surface 120b, third layer 130 with first major surface 130a and second major surface 130b. Third layer 130 is interposed between the second major surface 110b of the first layer 110 and the second major surface 120b of the second layer 120. Deformable membrane 301 further includes a first arrangement 140 comprising a plurality of first structures 142, with corresponding first void regions 144, interposed between the second major surface 110b of the first layer 110 and first major surface 130a of third layer 130. Each first structure 142 has a first surface 142a facing the second major surface 110b of the first layer 110, a second surface 142b facing the first major surface 130a of the third layer 130 and an imaginary axis, Z1, aligned perpendicular to and through the centroid of first surfaces 142a. In FIG. 3C, projections of first surfaces 142a of first structures 142 onto the plane of arrangement 150 are represented by the small, dashed rectangles 142c. In other embodiments, the first surfaces 142a of the first structures 142 may have any first structure first surface shape. Deformable membrane 301 includes a second arrangement 150 comprising a plurality of second structures 152, with corresponding first void regions 154, interposed between second major surface 120b of second layer 120 and second major surface 130b of third layer 130. The plurality of second structures 152 substantially surround each of the first structures 142. In some embodiments, void regions 154 include channels 154c that allow a fluid, e.g. a gas, such as air, to flow through and out of arrangement 150. An imaginary upward scaled (i.e., scaled in size by a factor greater than one) first structure first surface shape having a perimeter P1 is shown in FIG. 3C (rectangle with perimeter P1). The imaginary upward scaled first structure first surface shape (rectangle with perimeter P1 in FIG. 3C) shares the same centroid as corresponding first structure 142 and is scaled by a factor larger than 1. Perimeter P1 intersects four structures 152, in this embodiment. The perimeter P1 of the imaginary upward scaled first structure first surface shape (rectangle in FIG. 3C) intersects the four structures 152 along about 90% of the perimeter length of P1. The surface of the imaginary upward scaled first structure (rectangle in FIGS. 3C and 3D) may be perpendicular to the imaginary axis Z1 of first structures 142.

In some embodiments of deformable membranes of the present disclosure, the first structures of the first arrangement have corresponding imaginary axes aligned perpendicular to and running through the centroids of their first surfaces, at least one of the imaginary axes Z1, at least about 25% of the imaginary axes Z1, at least about 50% of the imaginary axes Z1, at least about 75% of the imaginary axes Z1, at least about 90% of the imaginary axes Z1 or even all the imaginary axes Z1, of the first structures of the first arrangement is substantially surrounded by the one or more second structures of the second arrangement such that an imaginary perimeter P1 in a region of the second arrangement intersects the at least one or more second structures of the second arrangement along at least about 50% of the perimeter length, along at least about 55% of the perimeter length, along at least about 60% of the perimeter length, along at least about 65% of the perimeter length, along at least about 70% of the perimeter length, along at least about 75% of the perimeter length, along at least about 80% of the perimeter length, along at least about 80% of the perimeter length, along at least about 85% of the perimeter length, along at least about 90% of the perimeter length, along at least about 95% of the perimeter length, or even 100% of the perimeter length, wherein the imaginary perimeter is drawn perpendicular to and around the imaginary axis of a first structure, has an identical shape as that of the perimeter of the first structure and has a size scaled to be greater than at least one times the perimeter of the first structure.

Yet another embodiment of a deformable membrane, according to the present disclosure, is shown in FIGS. 3E and 3F. FIG. 3E is a schematic cross-sectional top view of a plane running through and parallel to second arrangement 150 of deformable membrane 302 while FIG. 3F is the corresponding schematic cross-sectional side view of deformable membrane 302 along line W-W of FIG. 3E. FIGS. 3E and 3F show deformable membrane 302 which includes first layer 110 having second major surface 110b, second layer 120 having second major surface 120b, third layer 130 with first major surface 130a and second major surface 130b. Third layer 130 is interposed between the second major surface 110b of the first layer 110 and the second major surface 120b of the second layer 120. Deformable membrane 302 further includes a first arrangement 140 comprising a plurality of first structures 142, with corresponding first void regions 144, interposed between the second major surface 110b of the first layer 110 and first major surface 130a of third layer 130. Each first structure 142 has a first surface 142a facing the second major surface 110b of the first layer 110, a second surface 142b facing the first major surface 130a of the third layer 130 and an imaginary axis, Z1, aligned perpendicular to and through the centroid of first surfaces 142a. In FIG. 3E, projections of first surfaces 142a of first structures 142 onto the plane of arrangement 150 are represented by the small, dashed rectangles 142c. In other embodiments, the first surfaces 142a of the first structures 142 may have any first structure first surface shape. Deformable membrane 302 includes a second arrangement 150 comprising a plurality of second structures 152, with corresponding first void regions 154, interposed between second major surface 120b of second layer 110 and second major surface 130b of third layer 130. The plurality of second structures 152 substantially surround each of the first structures 142. In some embodiments, void regions 154 include channels 154c that allow a fluid, e.g. a gas, such as air, to flow through and out of arrangement 150. An imaginary, enlarged, first structure first surface shape having a perimeter P2 is shown in FIG. 3E (rectangle with perimeter P2). The perimeter P2 is generated by enlarging the perimeter of a first structure first surface perimeter by an arbitrary distance dₐ. The arbitrary distance may be no greater than the length of the force sensing capacitor element. The imaginary, enlarged first structure first surface shape (rectangle with perimeter P2 in FIG. 3E) shares the same centroid as corresponding first structure 142. Perimeter P2 intersects four structures 152, in this embodiment. The perimeter P2 of the imaginary, enlarged first structure first surface shape (rectangle in FIG. 3E) intersects the four structures 152 along about 90% of the perimeter length of P1. The surface of the imaginary, enlarged first structure (rectangle in FIGS. 3E and 3F) may be perpendicular to the imaginary axis Z1 of first structures 142.

In some embodiments of deformable membranes of the present disclosure, the first structures of the first arrangement have corresponding imaginary axes aligned perpendicular to and running through the centroids of their first surfaces, at least one of the imaginary axes Z1, at least 25% of the imaginary axes Z1, at least 50% of the imaginary axes Z1, at least 75% of the imaginary axes Z1, at least about 90% of the imaginary axes Z1 or even all the imaginary axes Z1, of the first structures of the first arrangement is substantially surrounded by the one or more second structures of the second arrangement such that an imaginary perimeter P2 in a region of the second arrangement intersects the at least one or more second structures of the second arrangement along at least about 50% of the perimeter length, along at least about 55% of the perimeter length, along at least about 60% of the perimeter length, along at least about 65% of the perimeter length, along at least about 70% of the perimeter length, along at least about 75% of the perimeter length, along at least about 80% of the perimeter length, along at least about 80% of the perimeter length, along at least about 85% of the perimeter length, along at least about 90% of the perimeter length, along at least about 95% of the perimeter length, or even 100% of the perimeter length, wherein the imaginary perimeter is drawn perpendicular to and around the imaginary axis of a first structure, has been enlarged by an arbitrary distance relative to the perimeter of the first surface of the first structure and the arbitrary distance is no greater than the length of the force sensing capacitor element.

In any of the preceding embodiments of the deformable membrane the first arrangement comprising a plurality of first structures, the second arrangement comprising one or more second structures or both of the first arrangement and second arrangement may be a two-dimensional arrangement of structures, i.e. the patterns of the first structures, the patterns of the one or more second structures or both may be a two-dimensional arrangement of structures, e.g. an array of posts, a rectangular grid array, a hexagonal grid array and the like.

Other layers can be included in the deformable membrane including adhesive layers. Adhesives useful in the deformable membranes and force-sensing capacitor elements of the present disclosure include, but are not limited to, pressure sensitive adhesive and cure in place adhesives. Cure in place adhesives include adhesive-solvent solutions where the final adhesive becomes tacky upon removal of solvent. Cure in place adhesives may be cured by actinic radiation, including UV or visible light. Cure in place adhesives may be cured by application of heat, or stated differently elevated temperature (e.g., thermoset polymer). Cure in place adhesives may also be moisture cure adhesives. The adhesives may be used to laminate various layers/components of the deformable members and force-sensing capacitor elements together. Cure in place adhesives are preferred adhesives in the deformable membranes and force sensing capacitor elements of the present disclosure. The deformable member may be a single unitary structure, fabricated for example, by conventional polymer injection molding techniques. The first, second and/or third layers of the deformable membrane may be laminated to the corresponding first structures of the first arrangement and/or second structures of the second arrangement through the use of appropriate adhesive layers. Some or all of the adhesive layers may be the same, i.e. the same chemical composition. All of the adhesive layers may be different, i.e. all have different chemical compositions. FIG. 1E shows deformable membrane 102 having the identical construction as deformable membrane 100, except deformable membrane 102 includes adhesive layers 170b and 170c. Adhesive layer 170b adheres first layer 110 to first structures 142 of first arrangement 140 through second major surface 110b and first surfaces 142a of first structures 142. Adhesive layer 170c adheres second layer 120 to second structures 152 of second arrangement 150 through second major surface 120b and first surfaces 152a of second structures 152. FIG. 1F shows deformable membrane 103 having the identical construction to deformable membrane 100, except deformable membrane 103 includes adhesive layers 170d and 170e. Adhesive layer 170d adheres third layer 130 to first structures 142 of first arrangement 140 through first major surface 130a and second surfaces 142b of first structures 142. Adhesive layer 170e adheres third layer 130 to second structures 152 of second arrangement 150 through second major surface 130b and second surfaces 152b of second structures 152. Adhesive layer 170e also adheres third layer 130 to optional third structures 162 through second major surface 130b and first surfaces 162a of third structures 162. Embodiments of the deformable membranes or force-sensing capacitor elements, wherein one or more layers are attached to one or more structures, are not limited by any particular means of adhering, bonding, or fusing of the attached materials. The first arrangement and/or second arrangement may be formed directly on the corresponding first, second and/or third layers. The adhesives may be used to laminate or adhere any of the electrodes to the desired major surface of the first layer, second layer and/or third layer. As an alternative to adhesive bonding, the layers and structures of the deformable membranes, electrodes, capacitors, and capacitive sensing elements of the present disclosure may be fused by application of heat.

In a given region of a force-sensing capacitor element, the ratio of the sum of the first surface area of the first structures in the region to the surface area of the region may be defined as a first fill factor. The first surfaces 142a of the first structures 142 of any of the embodiments of the present disclosure may have a first fill factor of at least about 1%, at least about 2%, at least about 5%, at least about 7%, or even at least about 10%; less than 90%, less than about 75%, less than about 50% or even less than about 30%. In some embodiments, the first fill factor may be between about 1% and about 90%, between about 2% and about 75%, between about 5% and about 50%, between about 7% and 45% or even between about 10% and 30%. The region of the force sensing capacitor element used to define the first fill factor may have a surface area greater than about 1%, greater than about 5%, greater than about 10%, greater than about 20%, greater than about 30%, greater than about 40% or even greater than about 50% of the total surface area of the force-sensing capacitor element; less than about 99%, less than about 95%, less than about 90%, less than about 80%, less than about 70% or even less than about 60% of the total surface area of the force-sensing capacitor element.

In a given region of a force-sensing capacitor element, the ratio of the sum of the first surface area of the second structures in the region to the surface area of the region may be defined as a second fill factor. The first surfaces 152a of the second structures 152 of any of the embodiments of the present disclosure may have a second fill factor of at least about 1%, at least about 2%, at least about 5%, at least about 7%, or even at least about 10%; less than 90%, less than about 75%, less than about 50% or even less than about 30%. In some embodiments, the second fill factor may be between about 1% and about 90%, between about 2% and about 75%, between about 5% and about 50%, between about 7% and 45%, or even between about 10% and 30%. The region of the force sensing capacitor element used to define the second fill factor may have a surface area greater than about 1%, greater than about 5%, greater than about 10%, greater than about 20%, greater than about 30%, greater than about 40% or even greater than about 50% of the total surface area of the force-sensing capacitor element; less than about 99%, less than about 95%, less than about 90%, less than about 80%, less than about 70% or even less than about 60% of the total surface area of the force-sensing capacitor element.

The total fill factor of first surfaces of the first and second structures, being the sum of the first fill factor and the second fill factor as described above, for any of the embodiments of the present disclosure, may be at least about 2%, at least about 4%, at least about 10%, at least about 14%, or even at least about 20%; less than 90%, less than about 75%, less than about 50% or even less than about 30%. In some embodiments the total fill factor may be between about 2% and about 90%, between about 4% and about 75%, between about 10% and about 50%, between about 14% and 45%, or even between about 20% and 30%. In some embodiments, the total fill factor may be between about 50% and about 99%, between about 60% and about 90%, or even between about 70% and about 80%. The region of the force sensing capacitor element used to define the total fill factor may have a surface area greater than about 1%, greater than about 5%, greater than about 10%, greater than about 20%, greater than about 30%, greater than about 40% or even greater than about 50% of the total surface area of the force-sensing capacitor element; less than about 99%, less than about 95%, less than about 90%, less than about 80%, less than about 70% or even less than about 60% of the total surface area of the force-sensing capacitor element.

In some Examples, the force-sensing capacitor elements comprised a total fill factor of less than 65%, more preferably less than 60%, even more preferably even less than 50%, even more preferably less than 45%, even more preferably less than 40%. In some embodiments, the total fill factor may be between 10% and 65%, in some embodiments between 10% and 60%, in some embodiments between 10% and 50%, in some embodiments between 10% and 40%. In some preferred embodiments, each of the aforementioned total fill factor ranges may exist in combination with greater than 50% of circumference length intersecting second structures, for a circumference of a circle C1 (e.g., imaginary circle C1) having an arbitrary radius R drawn around an axis (e.g., imaginary axis) aligned perpendicular to and running through the centroid of the first surface of a first structure, in some cases greater than 75%, in some cases greater than 80%, in some cases greater than 85%, in some cases greater than 90%, and in some cases greater than 92.5%. For example, in some embodiments, the force-sensing capacitor elements comprise a total fill factor of less than 65% (for example between 10% and 65%), and greater than 50% (for example greater than 75%) of circumference length intersecting second structures, for a circumference of a circle C1 (e.g., imaginary circle C1) having an arbitrary radius R drawn around an axis (e.g., imaginary axis) aligned perpendicular to and running through the centroid of the first surface of a first structure. As another example, in some embodiments, the force-sensing capacitor elements comprise a total fill factor of less than 50% (for example between 10% and 50%), and greater than 80% of circumference length intersecting second structures, for a circumference of a circle C1 (e.g., imaginary circle C1) having an arbitrary radius R drawn around an axis (e.g., imaginary axis) aligned perpendicular to and running through the centroid of the first surface of a first structure. As yet another example, in some embodiments, the force-sensing capacitor elements comprise a total fill factor of less than 40% (for example between 10% and 40%), and greater than 90% of circumference length intersecting second structures, for a circumference of a circle C1 (e.g., imaginary circle C1) having an arbitrary radius R drawn around an axis (e.g., imaginary axis) aligned perpendicular to and running through the centroid of the first surface of a first structure. For the aforementioned levels of total fill factor and amount by which second structures surround first structures, the first surfaces of the first structures are offset from the first surfaces of the second structures; also the first structures are offset from the second structures.

At least one of the first, second and third layers and at least one of the plurality of first structures of the first arrangement, the one or more second structures of the second arrangement and the third structures may include filler particles. Fillers include but are not limited to organic or inorganic particles or fibers, plasticizers, processing aides, thermal or UV/Vis light inhibitors, flame retardants.

Particularly useful materials for any of the first layer, second layer, third layer, first structures, and one or more second structures are silicone elastomers. Silicone materials can be fabricated to include structures according to, for example, U. S. Publ. Patent Application No. 2013/040073 (Pett, et.al.).

The fabrication of first structures and second structures, in registration, according to any of the deformable membranes, individual capacitors or force-sensing capacitor elements set forth herein, can be achieved by methods known in the art, for example through precision molding and casting. Such methods of processing are disclosed in, for example, U.S. Pat. No. 7,767,273 (Huizinga, et. al.).

The deformable membranes of the present disclosure are particularly suited for use in force-sensing capacitor elements and any of the previously described deformable membrane embodiments may be used in any of the force-sensing capacitor element embodiments described herein. In order to fabricate a force-sensing capacitor element with the deformable membranes of the present disclosure, electrodes, e.g. electrode pairs, need to be incorporated with the deformable membranes. The deformable membranes or parts thereof may function as the dielectric of the force-sensing capacitor elements. The positions of the electrodes with respect to the deformable membrane structure, generally, coincide with the deformable regions of the deformable membrane, e.g. the region of the deformable membrane proximate or in contact with the first structures and the second void regions. By positioning the electrodes in such a manner, one can to take advantage of a change in thickness of the deformable membrane and change in height, e.g. height h₂, between the second major surface of the second layer and the second major surface of the third layer in the second void regions, in response to an applied force, which will result in a change in capacitance in the deformed region, i.e. a region proximate to the applied force on the surface of the force-sensing capacitor element. Capacitance of one or more of the individual capacitors will change as the deformable membrane compresses in response to an applied force on the first surface of the first layer. As the magnitude of this applied force will correlate with the magnitude of the dimensional changes of the deformable membrane and the magnitude of the dimensional changes of the deformable membrane will cause corresponding changes in the capacitance, a force-force sensing capacitor element may be obtained. A force-sensing capacitor element according to the present disclosure may include more than one capacitor, for example an arrangement or an array of capacitors, thus allowing for measuring the force (or stated differently, pressure) distribution across the force-sensing capacitor element (i.e., positional measurement of force or pressure).

The capacitance of the capacitor, and the change in capacitance with compression, can be measured using any of a variety of known drive electronics. As used herein, the term measure, as related to the capacitance or change in capacitance of a capacitor, may include estimation of the capacitance, as may be expressed in farads. Alternatively, as used herein, the term measure, as related to the capacitance or change in capacitance of a capacitor, may include indirect determination of the magnitude of capacitance of the capacitor through the behavior of that capacitor in a circuit (or, alternatively, the behavior of a circuit that includes the capacitor). The attachment of a capacitor of the present disclosure to a circuit that measures the capacitance is also described herein as attachment of the capacitor to drive electronics that measure the capacitance. Examples of known capacitance measurement circuits are reported in, for example, U.S. Publ. Patent Application Nos. 2010/073323 (Geaghan), 2008/142281 (Geaghan), 2009/167325 (Geaghan), and 2011/115717 (Hable, et. al.), all incorporated herein in their entirety, by reference. The capacitance and the change in capacitance with compression are indirect measures of the force (or stated alternatively, as elaborated upon above, the pressure) applied to the capacitor. In general, the applied force or applied pressure changes the shape of the capacitor due to strain of a material or materials of construction of the capacitor. The change in shape of the capacitor results in a change in capacitance. A capacitive sensing element, i.e. a force-sensing capacitor element, according to the present disclosure may include more than one capacitor, for example an array of capacitors, thus allowing for measuring the force (or stated differently, pressure) distribution across the sensing element (i.e., positional measurement of force or pressure). A capacitive sensing element according to the present disclosure may include spaced apart row and column electrodes (as shown in, for example, FIG. 2 of U.S. Publ. Patent Application No. 2013082970 (Frey, et. al.) incorporated herein in its entirety, by reference), the capacitance between which can be determined according to known methods of mutual capacitance detection, thus allowing for positionally measuring the force (or stated differently, pressure) distribution across the sensing element (i.e., positional measurement of force or pressure). In some embodiments, the aforementioned row electrodes may be embedded within or proximate to or in contact with the first major surface of the first layer, and the aforementioned column electrodes may be embedded within or proximate to or in contact with the first major surface of the second layer.

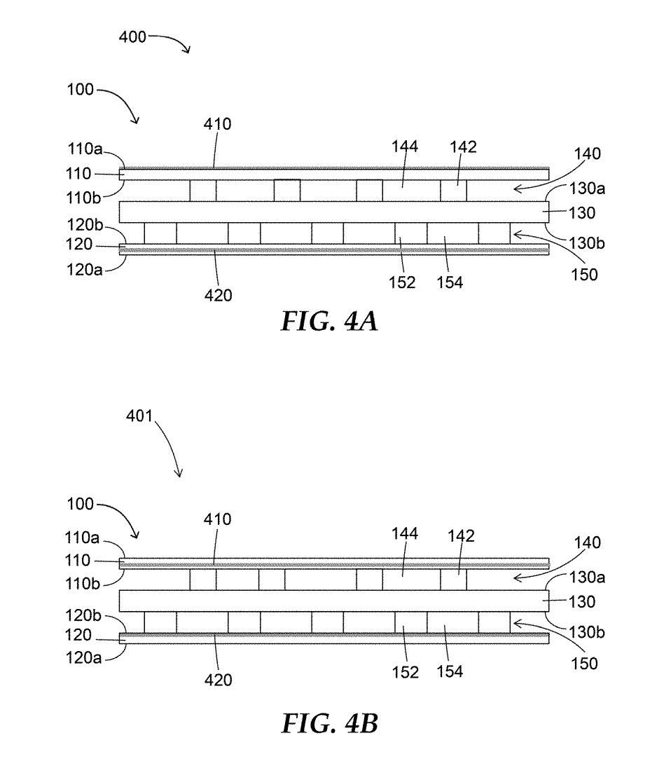

In some embodiments, a force-sensing capacitor element according to the present disclosure may include a deformable membrane according to any one of the previous described deformable membranes, a first electrode embedded within the first layer or proximate to or in contact with the first major surface of the first layer; and a second electrode embedded within the second layer or proximate to or in contact with one of the first major surface of the second layer and the second major surface of the second layer. An electrical charge, positive or negative, may be applied to the first and second electrodes. The electrical charge on the first electrode may be opposite that of the electrical charge on the second electrode. The dimensions of the first and second electrodes are not particularly limited. Their lengths and widths may be of similar dimensions as the dimensions of at least one of that of the first major surfaces of the first and second layer of the deformable membrane. At least one of the first and second electrodes may be planar electrodes. The first and second electrodes may have one or more electrical leads, providing a means of electrical connection to other electrical components and/or devices. Throughout this disclosure, if an electrode is said to be “embedded” in a layer, it can be fully embedded, i.e. fully enclosed by the layer or it can be partially embedded, i.e. part of the electrode may be protruding above a major surface of the layer. Throughout this disclosure, if an electrode is said to be proximate to a major surface of a layer, the electrode may be in contact with the major surface of the layer or one or more additional layers may be interposed between the electrode and the major surface of the layer, with the electrode in contact with the surface of the adjacent additional layer. Several specific, but non-limiting, embodiments are shown in FIGS. 4A and 4B

Referring now to FIG. 4A, force-sensing capacitor element 400 includes deformable membrane 100, as previously described and without optional third structures 162, a first electrode 410 proximate to or in contact with the first major surface 110a of first layer 110 and a second electrode 420 embedded within the second layer 120. Referring now to FIG. 4B, force-sensing capacitor element 401 includes deformable membrane 100, as previously described and without optional third structures 162, a first electrode 410 embedded within the first layer 110 and a second electrode 420 proximate to or in contact with the second major surface 120b of second layer 120.

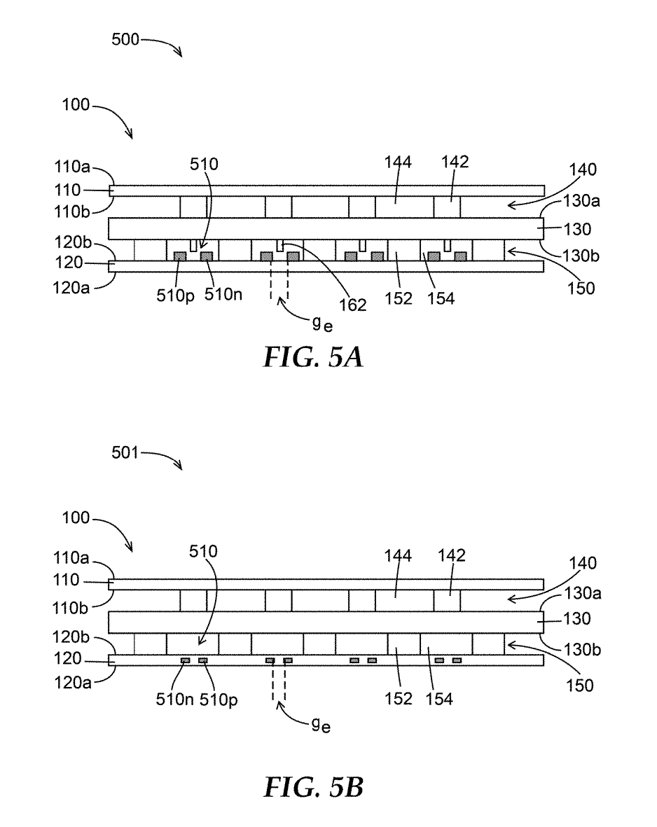

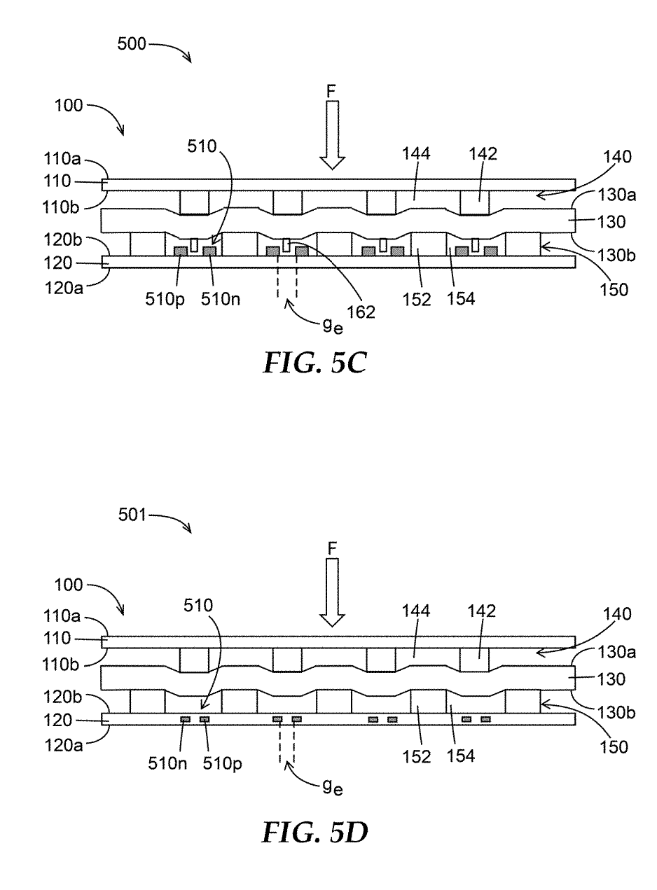

In other embodiments, a force-sensing capacitor element according to the present disclosure may include a deformable membrane according to anyone of the previous described deformable membranes, at least one electrode pair embedded within the second layer or proximate to or in contact with at least one of the first and second major surfaces of the second layer, wherein each of the at least one electrode pair comprises a first electrode and a second electrode separated by a gap and each of the at least one electrode pair is aligned with a second void region of the second arrangement, through the thickness of the deformable membrane. The force-sensing capacitor element may include a single capacitor or a plurality of capacitors. An electrical charge, positive or negative, may be applied to the first and second electrodes. The electrical charge on the first electrode may be opposite that of the electrical charge on the second electrode. The number of electrode pairs may be the same as the number of the first structures and the correlation between the electrode pairs and the first structures may be a one to one correlation. The number of the at least one electrode pair may be greater than the number of the first structures or the number of the at least one electrode pairs may be less than the number of first structures. The size and shape of the first and second electrodes and the gap are only limited in that they are selected based on the size and shape of the second void regions, in order that the at least one electrode pairs align with the second void regions of the second arrangement, though the thickness of the deformable membrane. The electrode pairs may be contained within or may be aligned, through the thickness of the deformable membrane, within the boundaries of the second void regions of the second arrangement. The at least one electrode pair may be aligned, through the thickness of the deformable membrane, with the first structures of the first arrangement. The dimensions of the first and second electrodes, although being at least somewhat smaller in width (w₄ of FIG. 1B) and height (h₂ of FIG. 1B), may scale to the size of the second void regions. The shape of the first and second electrodes may mimic the shape of the second void regions. The first and second electrodes may be planar electrodes. The first and second electrodes may have one or more electrical leads, providing a means of electrical connection to other electrical components and/or devices. The first and second electrodes of electrode pairs, each pair defining a capacitor, can be electrically connected to a circuit that measures the capacitance, also described herein as being electrically connected or attached to drive electronics that measure the capacitance. Several specific, but non-limiting, embodiments are shown in FIGS. 5A, 5B, 5C and 5D.

Referring now to FIG. 5A, force-sensing capacitor element 500 includes deformable membrane 100, as previously described and includes optional third structures 162 in contact with second major surface 130b of third layer 130, electrode pairs 510, including first electrodes 510p and second electrodes 510n separated by gap gₑ, proximate to or in contact with the second major surface 120b of second layer 120. Each of the electrode pairs 510 are aligned with a second void region 154 of the second arrangement 150, through the thickness of the deformable membrane. Referring now to FIG. 5B, force-sensing capacitor element 501 includes deformable membrane 100, as previously described and without optional third structures 162, electrode pairs 510, including first electrodes 510p and second electrodes 510n separated by a gap, gₑ, embedded within second layer 120.

FIG. 5C shows force-sensing capacitor element 500 of FIG. 5A with a force F applied to first major surface 110a of first layer 110 of deformable membrane 100. Force F compresses deformable membrane 100, causing the total thickness of the deformable membrane to decrease, compared to the uncompressed state. Force F urges structures 142 into third layer 130 causing third layer 130 to deflect into void regions 154, while second structures 152 provide support for third layer 130. In void regions 154 where third layer 130 has deflected, the distance between second major surface 130b and second major surface 120b is decreased. The change in thickness between second major surface 130b and second major surface 120b may cause a corresponding change in the capacitance between electrode pairs 510. More specifically, the proximity of third structures 162 to electrode pairs 510 is adjusted by application of force F. Increasing the proximity of a structure 162 to an electrode pair 510 can place higher permittivity material within the electric field between a first electrode 510n and a second electrode 510p when baised (higher, relative to that of void filling substance, for example air, with relative permittivity of approximately one). The extent of increased proximity (decreased separation) between a structure 162 and an electrode pair 510, detectable as a change in capacitance between electrodes of the electrode pair 510, serves as an indirect measure of applied force to the capacitor or force-sensing capacitor element. As the change in thickness correlates to the magnitude of the force F, a force-sensing capacitor element is obtained. Force F also urges third structures 162 into the gap region gₑ between first electrodes 510p and second electrodes 510n. Urging third structures 162 into the gap region gₑ between first electrodes 510p and second electrodes 510n may change the capacitance between electrode pairs 510. The change in capacitance between electrode pairs 510 may vary according to the depth that the third structures 162 move into the gap region gₑ. As the depth that the third structures 162 move into the gap region gₑ between first electrodes 510p and second electrodes 510n varies with respect to the amount of deformation of the deformable membrane 100, and the amount of deformation, i.e. dimensional change of the deformable membrane 100, varies with the magnitude of force F, a force-sensing capacitor element is obtained. The first and second electrodes of electrode pairs, each pair defining a capacitor, can be electrically connected to a circuit that measures the capacitance, also described herein as being electrically connected or attached to drive electronics that measure the capacitance.

In some embodiments, the electrical properties of the material comprising third structures 162 are tailored to enhance the magnitude of capacitance change between electrodes of electrode pairs 510, when third structures 162 are urged into the gap between electrodes of electrode pairs 510. Examples of tailored electrical properties for the third structures include high real part of the relative dielectric constant (also referred to herein as relative permittivity), for example greater than about 3, greater than about 5, greater than about 7, greater than about 10, greater than about 20, greater than about 30, greater than about 40, or even greater than about 50. Other examples of tailored electrical properties for the third structures include high dielectric loss tangent (also referred to herein as loss factor), for example greater than about 0.02, greater than about 0.05, greater than about 0.1, greater than about 0.15, greater than about 0.2, greater than about 0.25, or even greater than about 0.3. Other examples of tailored electrical properties for the third structures include high electrical bulk conductivity, for example, an electrical bulk conductivity greater than about 10⁻⁴ siemens/centimeter, greater than about 10⁻² siemens/centimeter, greater than about 1 siemen/centimeter, or even greater than about 10² siemens/centimeter.

FIG. 5D shows force-sensing capacitor element 501 of FIG. 5B with a force F applied to first major surface 110a of first layer 110 of deformable membrane 100. Force F compresses deformable membrane 100, causing the total thickness of the deformable membrane to decrease, compared to the uncompressed state. Force F urges structures 142 into third layer 130 causing third layer 130 to deflect into void regions 154, while second structures 152 provide support for third layer 130. In void regions 154 where third layer 130 has deflected, the distance between second major surface 130b and second major surface 120b is decreased. The change in thickness between second major surface 130b and second major surface 120b may cause a corresponding change in the capacitance between the one or more electrode pairs 510. More specifically, the proximity of third layer 130 to electrode pairs 510 is adjusted by application of force F. Increasing the proximity of a third layer 130 to an electrode pair 510 can place higher permittivity material within the electric field between a first electrode 510n and a second electrode 510p when baised (higher, relative to that of void filling substance, for example air, with relative permittivity of approximately one). The extent of increased proximity (decreased separation) between the third layer 130 and an electrode pair 510, detectable as a change in capacitance between electrodes of the electrode pair 510, serves as an indirect measure of applied force to the capacitor or force-sensing capacitor element. As the change in thickness correlates to the magnitude of the force F, a force-sensing capacitor element is obtained. The electrical properties of the third layer can be tailored to enhance the magnitude of capacitance change between electrodes of electrode pairs 510, when third layer 130 is urged closer to electrode pairs 510. Examples of tailored electrical properties for the third layer include high real part of the relative dielectric constant (also referred to herein as relative permittivity), for example greater than about 3, greater than about 5, greater than about 7, greater than about 10, greater than about 20, greater than about 30, greater than about 40, or even greater than about 50. Other examples of tailored electrical properties for the third layer include high dielectric loss tangent (also referred to herein as loss factor), for example greater than about 0.02, greater than about 0.05, greater than about 0.1, greater than about 0.15, greater than about 0.2, greater than about 0.25, or even greater than about 0.3. Other examples of tailored electrical properties for the third layer include high electrical bulk conductivity, for example, an electrical bulk conductivity greater than about 10⁻⁴ siemens/centimeter, greater than about 10⁻² siemens/centimeter, greater than about 1 siemen/centimeter, greater than about 10² siemens/centimeter.

In yet other embodiments, a force-sensing capacitor element according to the present disclosure may include a deformable membrane according to any one of the previous described deformable membranes, a plurality of first electrodes embedded within the third layer or proximate to or in contact with one of the first and second major surfaces of the third layer wherein each first electrode is aligned with a discrete second void region of the second arrangement comprising one or more structures; and at least one of (i) a plurality of second electrodes embedded within the second layer or proximate to or in contact with one of the first and second major surfaces of the second layer, wherein each second electrode is aligned, through the thickness of the deformable membrane, with a discrete second void region corresponding to a first electrode and, optionally, is aligned with a first electrode, through the thickness of the deformable membrane; and (ii) a third electrode embedded within the second layer or proximate to or in contact with one of the first and second major surfaces of the second layer, wherein the third electrode is aligned, through the thickness of the deformable membrane, with at least two discrete second void regions and, optionally, is aligned with at least two first electrodes, through the thickness of the deformable membrane. When each second electrode is said to be aligned with a discrete second void region corresponding to a first electrode, through the thickness of the deformable membrane, it is meant that a second electrode is aligned with or contained within the same second void region of a first electrode, through the thickness of the deformable membrane. When a second electrode is said to be aligned with a first electrode, it is meant that a projection of the first electrode, through the thickness of the deformable membrane, intersects, at least a portion, of a corresponding projection of the second electrode. The force-sensing capacitor element may include a single capacitor or a plurality of capacitors.

In some embodiments, an electrical charge, positive or negative, is applied to the first, second and third electrodes. In some embodiments, the electrical charge on the first electrode is opposite that of the electrical charge on the second or third electrode. The electrical charge on the first electrodes may be the same and the electrical charge on the second electrodes may be the same, but opposite that of the first electrodes. The electrical charge on the first electrodes may be the same and the electrical charge on the third electrode may be opposite that of the first electrodes. The number of first electrodes and second electrodes may be the same as the number of the first structures and the correlation between the first and second electrodes and the first structures may be a one to one to one correlation. At least one of the number of first electrodes and the number of second electrodes may be greater than the number of the first structures, and at least one of the number of first electrodes and the number of second electrodes may be less than the number of the first structures. The size and shape of first and second electrodes is only limited in that they are selected based on the size and shape of second void regions, in order that first electrodes align with a single second void region of the second arrangement and second electrodes align with the second void regions of the second arrangement, though the thickness of the deformable membrane. At least some of the plurality of first electrodes may be contained within or may be aligned through the thickness of the deformable membrane within the boundaries of the second void regions of the second arrangement. At least some of the plurality of second electrodes may be contained within or may be aligned through the thickness of the deformable membrane within the boundaries of the second void regions of the second arrangement. The dimensions of the first and second electrodes, although being at least somewhat smaller in width (w₄ of FIG. 1B) and height (h₂ of FIG. 1B), may scale to the size of the second void regions. The shape of the first and second electrodes may mimic the shape of the second void regions. The size and shape of the third electrode is not particularly limited. At least one of the first, second and third electrodes may be planar electrodes. The first, second and third electrodes may have one or more electrical leads, providing a means of electrical connection to other electrical components and/or devices.

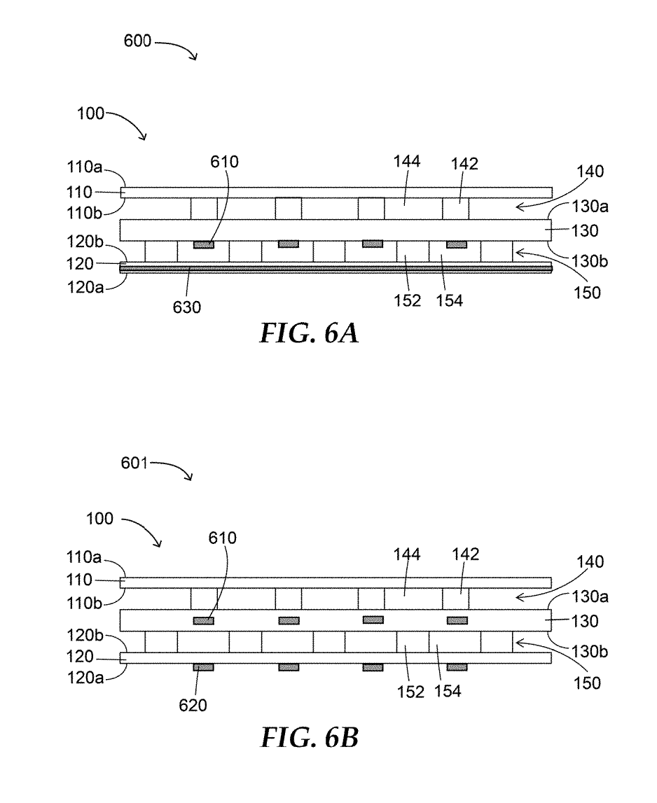

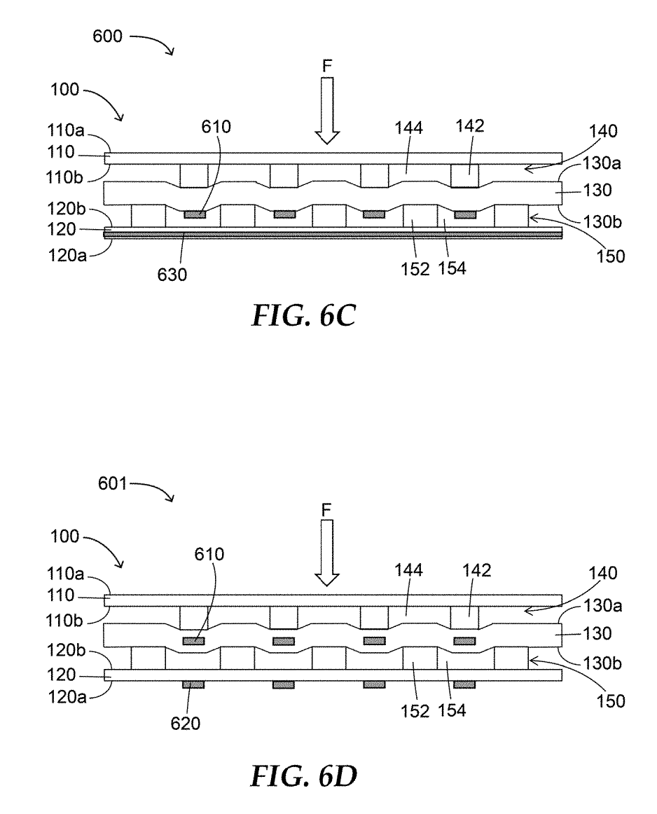

Several specific, but non-limiting, embodiments are shown in FIGS. 6A, 6B, 6C and 6D. Referring now to FIG. 6A, force-sensing capacitor element 600 includes deformable membrane 100, as previously described and without optional third structures 162, a plurality of first electrodes 610 proximate to or in contact with second major surface 130b of third layer 130 and a third electrode 630 embedded within second layer 120. Each of the first electrodes 610 are aligned with a single second void region 154 of the second arrangement 150, through the thickness of the deformable membrane 100. Referring now to FIG. 6B, force-sensing capacitor element 601 includes deformable membrane 100, as previously described and without optional third structures 162, a plurality of first electrodes 610 embedded within third layer 130 and a plurality of second electrodes 620 proximate to or in contact with first major surface 120a of second layer 120. Each of the first electrodes 610 is aligned with a single second void region 154 of the second arrangement 150, through the thickness of the deformable membrane 100. Each of the second electrodes 620 is aligned with a second void region 154 of the second arrangement 150, through the thickness of the deformable membrane 100.

FIG. 6C shows force-sensing capacitor element 600 of FIG. 6A with a force F applied to first major surface 110a of first layer 110 of deformable membrane 100. Force F compresses deformable membrane 100, causing the total thickness of the deformable membrane to decrease, compared to the uncompressed state. Force F urges structures 142 into third layer 130 causing third layer 130 to deflect into void regions 154, while second structures 152 provide support for third layer 130. In void regions 154 where third layer 130 has deflected, the distance between second major surface 130b and second major surface 120b is decreased and the corresponding distance between plurality of first electrodes 610 and third electrode 630 has also decreased. The change in thickness may cause a corresponding change in the capacitance between the plurality of first electrodes 610 and third electrode 630. As the change in thickness correlates to the magnitude of the force F, a force-sensing capacitor element is obtained.

FIG. 6D shows force-sensing capacitor element 600 of FIG. 6B with a force F applied to first major surface 110a of first layer 110 of deformable membrane 100. Force F compresses deformable membrane 100, causing the total thickness of the deformable membrane to decrease, compared to the uncompressed state. Force F urges structures 142 into third layer 130 causing third layer 130 to deflect into void regions 154, while second structures 152 provide support for third layer 130. In void regions 154 where third layer 130 has deflected, the distance between second major surface 130b and second major surface 120b is decreased and the corresponding distance between plurality of first electrodes 610 and the corresponding plurality of second electrodes 620 has also decreased. The change in thickness may cause a corresponding change in the capacitance between the plurality of first electrodes 610 and the plurality of first electrode 620. As the change in thickness correlates to the magnitude of the force F, a force-sensing capacitor element is obtained.

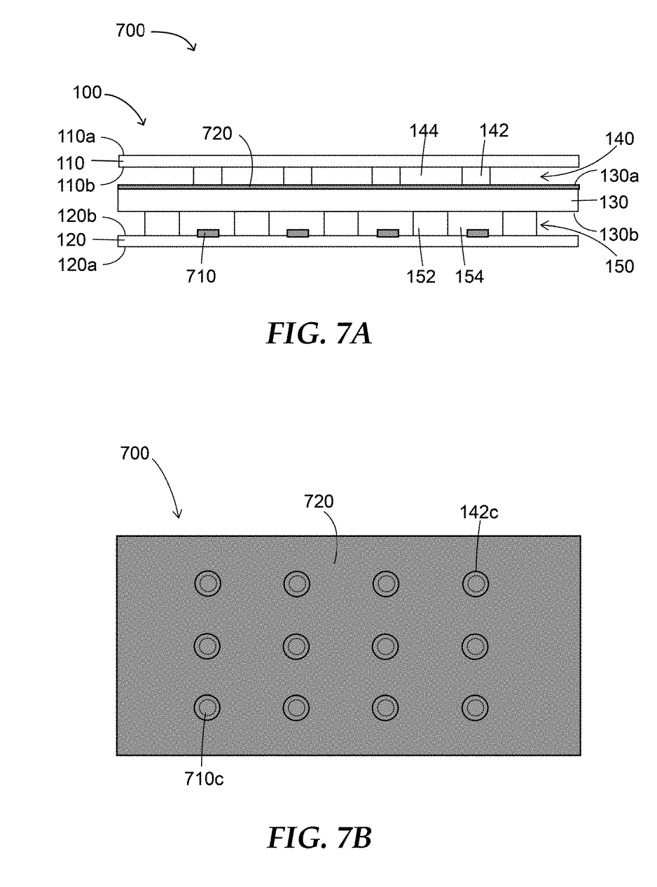

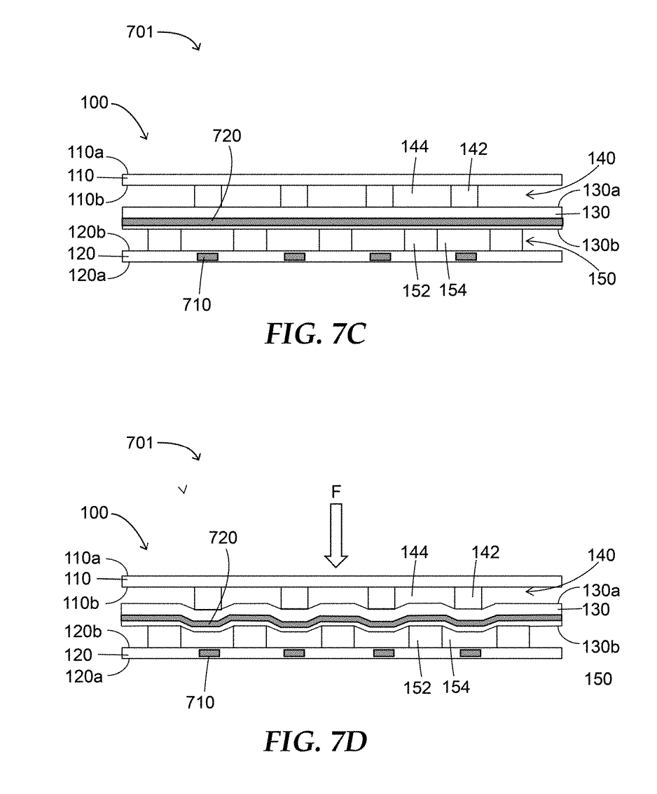

In other embodiments, a force-sensing capacitor according to the present disclosure may include a deformable membrane according to anyone of the previous described deformable membranes, a plurality of first electrodes embedded within the second layer or proximate to or in contact with one of the first and second major surfaces of the second layer wherein each first electrode is aligned with a discrete second void region of the second arrangement comprising one or more structures; and a second electrode embedded within the third layer or proximate to or in contact with one of the first and second major surfaces of the third layer, wherein the second electrode is aligned, through the thickness of the deformable membrane, with at least two discrete second void regions corresponding to at least two first electrode and, optionally, is aligned with at least one first electrode, through the thickness of the deformable membrane. When each second electrode is said to be aligned with at least two discrete second void region corresponding to at least two first electrodes, through the thickness of the deformable membrane, it is meant that a second electrode is aligned with or contained within the same two second void region of the first two electrode, through the thickness of the deformable membrane. When a second electrode is said to be aligned with at least one first electrode, it is meant that a projection of the first electrode, through the thickness of the deformable membrane, intersects, at least a portion, of a corresponding projection of the second electrode. The force-sensing capacitor element may include a single capacitor or a plurality of capacitors. In some embodiments, an electrical charge, positive or negative, is applied to the plurality of first electrodes and the second electrode. The electrical charge on the first electrodes may be opposite that of the electrical charge on the second electrode. The electrical charge on the first electrodes may be all the same, but opposite that of the second electrode. The number of first electrodes may be the same as the number of the first structures and the correlation between the first and electrodes and the first structures may be a one to one correlation. The number of first electrodes may be greater than the number of the first structures or the number of first electrodes may be less than the number of the first structures. The size and shape of the first electrodes is only limited in that they are selected based on the size and shape of second void regions, in order that the first electrodes align with a single second void region of the second arrangement, through the thickness of the deformable membrane. At least some of the plurality of first electrodes may be contained within or may be aligned through the thickness of the deformable membrane within the boundaries of the second void regions of the second arrangement. The dimensions of the first electrodes, although being at least somewhat smaller in width (w₄ of FIG. 1B) and height (h₂ of FIG. 1B), may scale to the size of the second void regions. The shape of the first electrodes may mimic the shape of the second void regions. At least one of the first and second electrodes may be substantially planar electrodes. The first and second electrodes may have one or more electrical leads, providing a means of electrical connection to other electrical components and/or devices. Several specific, but non-limiting, embodiments are shown in FIGS. 7A, 7B, 7C and 7D.

Referring now to FIG. 7A, force-sensing capacitor element 700 includes deformable membrane 100, as previously described and without optional third structures 162, a plurality of first electrodes 710 proximate to or in contact with second surface 120b of second layer 120 and a second electrode 720 proximate to or in contact with first major surface 130a of third layer 130. Each of the first electrodes 710 are aligned with a single second void region 154 of the second arrangement 150, through the thickness of the deformable membrane 100. Referring now to FIG. 7B (a schematic cross-sectional top view through a plane of second electrode 720, the plane being parallel to first major surface 130, of force-sensing capacitor element 700 of FIG. 7A), second electrode 720 is a thin sheet, i.e. a thin, continuous plane. Projections of first structures 142 are represented by dashed circles 142c on the plane of second electrode 720. Projections of the plurality of first electrodes 710 on the plane of second electrode 720 are represented by the small, dashed circles 710c. In this embodiment, the plurality of first structures 142 of arrangement 140, are in a two-dimensional, rectangular grid pattern. Plurality of first electrodes 710 are arranged in a pattern that mimics the pattern of the plurality of first structures 142, i.e. first electrodes 710 are arranged in a similar rectangular grid pattern as that of the plurality of first structures 142.

FIG. 7C shows a force-sensing capacitor element 701 including deformable membrane 100, as previously described and without optional third structures 162, a plurality of first electrodes 710 embedded within second layer 120 and a second electrode 720 embedded within third layer 130. Each of the first electrodes 710 are aligned with a single second void region 154 of the second arrangement 150, through the thickness of the deformable membrane 100.

FIG. 7D shows force-sensing capacitor element 701 of FIG. 7C with a force F applied to first major surface 110a of first layer 110 of deformable membrane 100. Force F compresses deformable membrane 100, causing the total thickness of the deformable membrane to decrease, compared to the uncompressed state. Force F urges structures 142 into third layer 130 causing third layer 130 to deflect into void regions 154, while second structures 152 provide support for third layer 130. In void regions 154 where third layer 130 has deflected, the distance between second major surface 130b and second major surface 120b is decreased and the corresponding distance between first electrodes 710 and second electrode 720 has also decreased. The change in thickness may cause a corresponding change in the capacitance between first electrodes 710 and second electrode 720. As the change in thickness correlates to the magnitude of the force F, a force-sensing capacitor element is obtained.

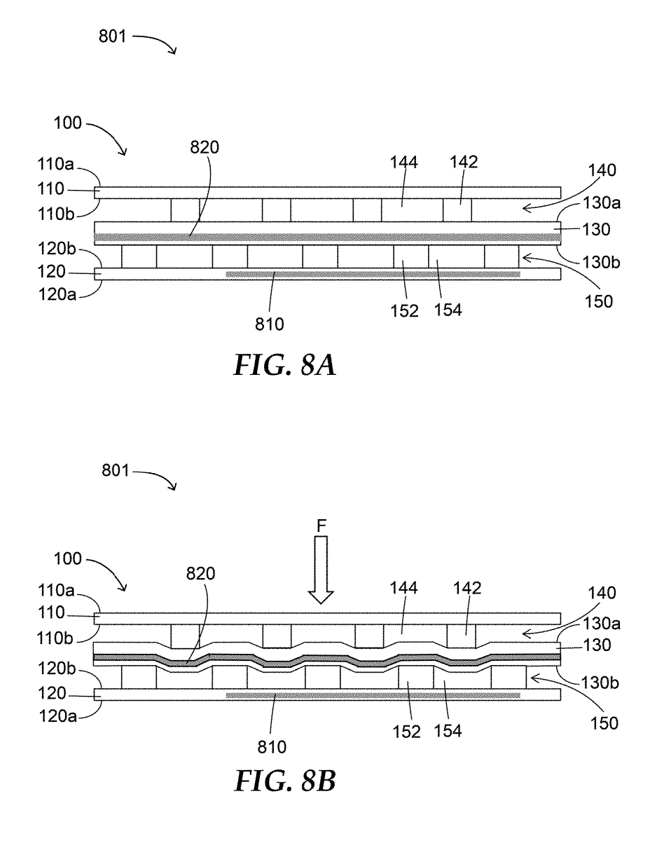

In yet other embodiments, a force-sensing capacitor element according to the present disclosure may include a deformable membrane according to anyone of the previous described deformable membranes, a first electrode embedded within the second layer or proximate to or in contact with one of the first and second major surfaces of the second layer, wherein the first electrode is aligned, through the thickness of the deformable membrane, with two or more discrete second void regions of the second arrangement; and a second electrode embedded within the third layer or proximate to or in contact with one of the first and second major surfaces of the third layer, wherein the second electrode is aligned, through the thickness of the deformable membrane, with at least one discrete second void region corresponding to the first electrode and, optionally, is aligned with the first electrode, through the thickness of the deformable membrane. When a second electrode is said to be aligned with a discrete second void region corresponding to a first electrode, through the thickness of the deformable membrane, it is meant that the second electrode is aligned with or contained within the same second void region of the first electrode, through the thickness of the deformable membrane. When a second electrode is said to be aligned with a first electrode, it is meant that a projection of the first electrode, through the thickness of the deformable membrane, intersects, at least a portion, of a corresponding projection of the second electrode. The force-sensing capacitor element may include a single capacitor or a plurality of capacitors. In some embodiments, an electrical charge, positive or negative, is applied to the first and second electrodes. The electrical charge on the first electrode may be opposite that of the electrical charge on the second electrode. The size and shape of first electrode is only limited in that they are selected based on the size and shape of second void regions, in order that the first electrodes align with at least two second void region of the second arrangement, though the thickness of the deformable membrane. The size of the second electrode is not particularly limited. At least one of the first and second electrodes may be substantially planar electrodes. The first and second electrodes may have one or more electrical leads, providing a means of electrical connection to other electrical components and/or devices. Several specific, but non-limiting, embodiments are shown in FIGS. 8A and 8B.

FIG. 8A shows a force-sensing capacitor element 801 including deformable membrane 100, as previously described and without optional third structures 162, first electrode 810 embedded within second layer 120 and a second electrode 820 embedded within third layer 130. In the schematic cross-sectional view of FIG. 8A, first electrode 810 is aligned with three, second void regions 154 of the second arrangement 150, through the thickness of the deformable membrane 100.

FIG. 8B shows force-sensing capacitor element 801 of FIG. 8A with a force F applied to first major surface 110a of first layer 110 of deformable membrane 100. Force F compresses deformable membrane 100, causing the total thickness of the deformable membrane to decrease, compared to the uncompressed state. Force F urges structures 142 into third layer 130 causing third layer 130 to deflect into void regions 154, while second structures 152 provide support for third layer 130. In void regions 154 where third layer 130 has deflected, the distance between second major surface 130b and second major surface 120b is decreased and the corresponding distance between first electrode 810 and second electrode 820 has also decreased. The change in thickness may cause a corresponding change in the capacitance between the plurality of first electrodes 810 and second electrode 820. As the change in thickness correlates to the magnitude of the force F, a force-sensing capacitor element is obtained.

In other embodiments, a force-sensing capacitor element includes a deformable membrane having first and second major surfaces, a first electrode and a second electrode, defining a capacitor, wherein the deformable membrane is engineered for its change in effective dielectric constant under compressive stress to combine with its change in thickness under compressive stress to yield an approximately linear dependence between the capacitance per unit area of the capacitor and the compressive stress, e.g the force applied to a major surface of the deformable membrane. The deformation of the deformable membrane at least approximately follows the relationship given in Equation [1], for example, with K being constant to within about 25%, about 10%, about 5%, or even about 2%, over a range of thickness compression, i.e. |□Tₒ/Tₒ| equal to about 2%, about 5%, about 10%, about 25%, about 50%, or even about 75%.

$$( \frac{d ( \frac{{ɛ}_{{eff}^{′}}}{t} )}{dp} ) = K \neq 0$$

where:
□_{eff}′=effective relative permittivity of the deformable insulator
P=applied compressive stress (pressure)
Tₒ=thickness of the deformable insulator
□Tₒ=the thickness of the deformable membrane without a force applied to a major surface−the thickness of the deformable membrane when a force is applied to a major surface, yielding a compressive stress
K=constant
   A force F applied to the capacitor, and therefore the membrane, compresses the membrane with controlled dependencies of compression (%) and effective relative permittivity on applied force per unit area (pressure) that is determined by the rational design and materials of construction of the membrane. The designs of the membranes, leading to the controlled dependencies, can be determined using experimentation or modeling (for example finite element modeling). The membranes may be fabricated using micro-replication, embossing, and lamination processes as are known in the art. The deformable membranes may include materials or design elements of the previous deformable membrane embodiments. The electrodes may be patterned or non-patterned. At least one of the first electrode and second electrode may be planar electrodes. The first and second electrodes may be substantially parallel to one another. At least one of the first and second electrodes may be substantially parallel to the deformable membrane. The force-sensing capacitor element may include a single capacitor or a plurality of capacitors.

For force-sensing capacitors of the present disclosure, the coefficient of determination for capacitance versus force is preferably between 0.8000 and 1.000 (e.g., from 0.8001 and 0.9999), more preferably between 0.9000 and 1.0000 (e.g., from 0.9001 and 0.9999), more preferably between 0.9500 and 1.0000 (e.g., from 0.9501 and 0.9999), more preferably between 0.9800 and 1.0000 (e.g., from 0.9801 and 0.9999), or most preferably between 0.9900 and 1.0000 (e.g., from 0.9901 and 0.9999). Relevant ranges of applied force for the aforementioned ranges of RSQ include ranges describable by the factor over which the force is varied. Preferably, the ranges of RSQ described above are associated with force that is varied over a factor of at least 1.5, more preferably at least 2, more preferably at least 3, more preferably at least 4, more preferably at least 5, and most preferably at least 10. In some embodiments, the ranges of RSQ described above are associated with force that is varied over a factor of from 1.5 to 10, and in some embodiments from 2 to 5.

In any of the preceding embodiments of the force-sensing capacitor element, the deformable membrane's first arrangement comprising a plurality of first structures, second arrangement comprising one or more second structures or both the first arrangement and second arrangement may be a two-dimensional arrangement of structures, i.e. the patterns of the first structures, the patterns of the one or more second structures or both may be a two-dimensional arrangement of structures, e.g. a rectangular grid array, a hexagonal grid array and the like.

The electrodes used in the force-sensing capacitor elements of the present disclosure may be metals or metal alloys, including but not limited to, indium-tin-oxide, aluminum, copper, silver and gold. The electrodes used in the force-sensing capacitor elements of the present disclosure may be electrically conductive composites containing one or more conductive particles, fibers, woven or non-woven mats and the like. The conductive particles, fibers, woven or non-woven mats may include the above metal. They also may be non-conductive particles, fibers, woven or non-woven mats that have been coated with a conductive material, e.g. a metal, including but not limited to, aluminum, copper, silver and gold. The electrodes used in the force-sensing capacitor elements may be in the form of thin films, e.g. a thin metal film or thin electrically conductive composite film. The thickness of the electrodes may be between about 0.1 microns and about 200 microns. The thickness may be greater than about 0.5 microns, greater than about 1 microns, greater than about 2 microns, greater than about 3 microns, greater than about 4 microns or even greater than about 5 microns; less than about 50, less than about 40 microns, less than about 30 microns, less than about 20 microns, or even less than 10 microns. The electrodes may be fabricated by know techniques in the art including, but not limited to, techniques commonly used to form indium-tin-oxide traces in present touch screen displays and techniques commonly used to form metal lines and vias in semiconductor manufacturing. Other useful techniques for fabricating the electrodes include screen printing, flexographic printing, inkjet printing, photolithography, etching, and lift-off processing. In embodiments where at least one electrode is embedded within at least one of the first, second and third layers, one or more vias and corresponding metal interconnects, e.g. conductive lines on the surface of a layer, may be used to facilitate electrical contact to the electrode(s).

The force-sensing capacitor elements of the present disclosure may be useful in various electronic devices. Electronic devices include (1) personal computers, (2) displays and monitors, (3) tablets or slate type computing devices, (4) personal electronic and or communication devices, such as for example, smart phones, digital music players and (5) any personal device whose function includes creating, storing or consuming digital media. In another embodiment, an electronic device comprises a force-sensing capacitor element of any of the proceeding embodiments. In yet another embodiment, a touch screen display comprises a force-sensing capacitor element of any of the proceeding embodiments.

Select embodiments of the present disclosure include, but are not limited to, the following:

In a first embodiment, the present disclosure provides a force-sensing capacitor element comprising:

a deformable membrane comprising
a first layer having first and second major surfaces,
a second layer having first and second major surfaces,
a third layer having first and second major surfaces interposed between the second major surface of the first layer and the second major surface of the second layer,
a first arrangement comprising a plurality of first structures, with corresponding first void regions, interposed between the second major surface of the first layer and the first major surface of the third layer, wherein each first structure has a first surface facing or in contact with the second major surface of the first layer and a second surface facing or in contact with the first major surface of the third layer, and
a second arrangement comprising one or more second structures, with corresponding second void regions, interposed between the second major surface of the second layer and the second major surface of the third layer, wherein each of the one or more second structures has a first surface facing or in contact with the second major surface of the second layer and a second surface facing or in contact with the second major surface of the third layer; and wherein each first surface of the first structures and each first surface of the one or more second structures are offset from one another such that there is no overlap between each first surface of the first structures and each first surface of the one or more second structures, through the thickness of the deformable membrane;

a first electrode embedded within the first layer or proximate to or in contact with the first major surface of the first layer; and

a second electrode embedded within the second layer or proximate to or in contact with one of the first major surface of the second layer and the second major surface of the second layer.

In a second embodiment, the present disclosure provides a force-sensing capacitor element comprising:

a deformable membrane comprising
a first layer having first and second major surfaces,
a second layer having first and second major surfaces,
a third layer having first and second major surfaces interposed between the second major surface of the first layer and the second major surface of the second layer,
a first arrangement comprising a plurality of first structures, with corresponding first void regions, interposed between the second major surface of the first layer and the first major surface of the third layer, wherein each first structure has a first surface facing or in contact with the second major surface of the first layer and a second surface facing or in contact with the first major surface of the third layer, and
a second arrangement comprising one or more second structures, with corresponding second void regions, interposed between the second major surface of the second layer and the second major surface of the third layer, wherein each of the one or more second structures has a first surface facing or in contact with the second major surface of the second layer and a second surface facing or in contact with the second major surface of the third layer; and wherein each first surface of the first structures and each first surface of the one or more second structures are offset from one another such that there is no overlap between each first surface of the first structures and each first surface of the one or more second structures, through the thickness of the deformable membrane; and

at least one electrode pair embedded within the second layer or proximate to or in contact with at least one of the first and second major surfaces of the second layer, wherein each of the at least one electrode pair comprises a first electrode and a second electrode separated by a gap and each of the at least one electrode pair is aligned with a second void region of the second arrangement, through the thickness of the deformable.

In a third embodiment, the present disclosure provides a force-sensing capacitor element comprising:

a deformable membrane comprising
a first layer having first and second major surfaces,
a second layer having first and major second surfaces,
a third layer having first and second major surfaces interposed between the second major surface of the first layer and the second major surface of the second layer,
a first arrangement comprising a plurality of first structures, with corresponding first void regions, interposed between the second major surface of the first layer and the first major surface of the third layer, wherein each first structure has a first surface facing or in contact with the second major surface of the first layer and a second surface facing or in contact with the first major surface of the third layer, and
a second arrangement comprising one or more second structures, with corresponding second void regions, interposed between the second major surface of the second layer and the second major surface of the third layer, wherein each of the one or more second structures has a first surface facing or in contact with the second major surface of the second layer and a second surface facing or in contact with the second major surface of the third layer; and wherein each first surface of the first structures and each first surface of the one or more second structures are offset from one another such that there is no overlap between each first surface of the first structures and each first surface of the one or more second structures, through the thickness of the deformable membrane;

a plurality of first electrodes embedded within the third layer or proximate to one of the first and second major surfaces of the third layer wherein each first electrode is aligned with a discrete second void region of the second arrangement comprising one or more structures; and

at least one of (i) a plurality of second electrodes embedded within the second layer or proximate to one of the first and second major surfaces of the second layer, wherein each second electrode is aligned, through the thickness of the deformable membrane, with a discrete second void region corresponding to a first electrode and, optionally, is aligned with a first electrode through the thickness of the deformable membrane; and (ii) a third electrode embedded within the second layer or proximate to one of the first and second major surfaces of the second layer, wherein the third electrode is aligned, through the thickness of the deformable membrane, with at least two discrete second void regions, and optionally, is aligned with at least two first electrodes, through the thickness of the deformable membrane.

In a forth embodiment, the present disclosure provides a force-sensing capacitor element comprising:

a deformable membrane comprising
a first layer having first and second major surfaces,
a second layer having first and major second surfaces,
a third layer having first and second major surfaces interposed between the second major surface of the first layer and the second major surface of the second layer,
a first arrangement comprising a plurality of first structures, with corresponding first void regions, interposed between the second major surface of the first layer and the first major surface of the third layer, wherein each first structure has a first surface facing or in contact with the second major surface of the first layer and a second surface facing or in contact with the first major surface of the third layer, and
a second arrangement comprising one or more second structures, with corresponding second void regions, interposed between the second major surface of the second layer and the second major surface of the third layer, wherein each of the one or more second structures has a first surface facing or in contact with the second major surface of the second layer and a second surface facing or in contact with the second major surface of the third layer; and wherein each first surface of the first structures and each first surface of the one or more second structures are offset from one another such that there is no overlap between each first surface of the first structures and each first surface of the one or more second structures, through the thickness of the deformable membrane;

a plurality of first electrodes embedded within the second layer or proximate to one of the first and second major surfaces of the second layer wherein each first electrode is aligned with a discrete second void region of the second arrangement comprising one or more structures; and

a second electrode embedded within the third layer or proximate to one of the first and second major surfaces of the third layer, wherein the second electrode is aligned, through the thickness of the deformable membrane, with at least two discrete second void regions corresponding to at least two first electrodes and, optionally, is aligned with at least one first electrode, through the thickness of the deformable membrane.

In a fifth embodiment, the present disclosure provides a force-sensing capacitor element comprising:

a deformable membrane comprising
a first layer having first and second major surfaces,
a second layer having first and second major surfaces,
a third layer having first and second major surfaces interposed between the second major surface of the first layer and the second major surface of the second layer,
a first arrangement comprising a plurality of first structures, with corresponding first void regions, interposed between the second major surface of the first layer and the first major surface of the third layer, wherein each first structure has a first surface facing or in contact with the second major surface of the first layer and a second surface facing or in contact with the first major surface of the third layer, and
a second arrangement comprising one or more second structures, with corresponding second void regions, interposed between the second major surface of the second layer and the second major surface of the third layer, wherein each of the one or more second structures has a first surface facing or in contact with the second major surface of the second layer and a second surface facing or in contact with the second major surface of the third layer; and wherein each first surface of the first structures and each first surface of the one or more second structures are offset from one another such that there is no overlap between each first surface of the first structures and each first surface of the one or more second structures, through the thickness of the deformable membrane;

a first electrode embedded within the second layer or proximate to one of the first and second major surfaces of the second layer wherein the first electrode is aligned, through the thickness of the deformable membrane, with two or more discrete second void regions of the second arrangement; and

a second electrode embedded within the third layer or proximate to one of the first and second major surfaces of the third layer, wherein the second electrode is aligned, through the thickness of the deformable membrane, with at least one discrete second void region corresponding to the first electrode and, optionally, is aligned with the first electrode, through the thickness of the deformable membrane.

In a sixth embodiment, the present disclosure provides a force-sensing capacitor element according to the first to fifth embodiments, wherein the deformable membrane further comprises a plurality of third structures proximate to or in contact with the second major surface of the third layer wherein each third structure coincides and overlaps, through the thickness of the deformable membrane, with a corresponding first structure of the first arrangement, and the third structures are located in the void regions of the second arrangement.

In a seventh embodiment, the present disclosure provides a force-sensing capacitor element according to the sixth embodiment, wherein the third structures are not in contact with the second major surface of the second layer.

In an eighth embodiment, the present disclosure provides a force-sensing capacitor element according to the first to seventh embodiments, wherein the first structures of the first arrangement have corresponding imaginary axes aligned perpendicular to and running through the centroids of their first surfaces, and wherein at least one of the imaginary axes of the first structures of the first arrangement is substantially surrounded by the one or more structures of the second arrangement such that an imaginary circle in a region of the second arrangement comprising one or more structures, having a radius r drawn around the at least one of the imaginary axes, intersects the at least one or more second structures of the second arrangement along at least 50% of the circle's circumference length.

In a ninth embodiment, the present disclosure provides a force-sensing capacitor element according to the first to eighth embodiments, wherein the first and second layers of the deformable membrane are substantially parallel.

In a tenth embodiment, the present disclosure provides a force-sensing capacitor element according to the first to ninth embodiments, wherein the second and third layers of the deformable membrane are substantially parallel.

In an eleventh embodiment, the present disclosure provides a deformable membrane for a force-sensing capacitor element comprising:

a first layer having first and second major surfaces;

a second layer having first and major second surfaces;

a third layer having first and second major surfaces interposed between the second major surface of the first layer and the second major surface of the second layer;

a first arrangement comprising a plurality of first structures, with corresponding first void regions, interposed between the second major surface of the first layer and the first major surface of the third layer, wherein each first structure has a first surface facing or in contact with the second major surface of the first layer and a second surface facing or in contact with the first major surface of the third layer;

a second arrangement comprising one or more second structures, with corresponding second void regions, interposed between the second major surface of the second layer and the second major surface of the third layer, wherein each of the one or more second structures has a first surface facing or in contact with the second major surface of the second layer and a second surface facing or in contact with the second major surface of the third layer; and wherein each first surface of the first structures and each first surface of the one or more second structures are offset from one another such that there is no overlap between each first surface of the first structures and each first surface of the one or more second structures, through the thickness of the deformable membrane; and

a plurality of third structures proximate to or in contact with the second major surface of the third layer wherein each third structure coincides and overlaps, through the thickness of the deformable membrane, with a corresponding first structure of the first arrangement, and the third structures are located in the void regions of the second arrangement.

In an twelfth embodiment, the present disclosure provides a deformable membrane for a force-sensing capacitor element comprising according to the eleventh, wherein the third structures are not in contact with the second major surface of the second layer.

In a thirteenth embodiment, the present disclosure provides a deformable membrane for a force-sensing capacitor element comprising:

a first layer having first and second major surfaces;

a second layer having first and major second surfaces;

a third layer having first and second major surfaces interposed between the second major surface of the first layer and the second major surface of the second layer;

a first arrangement comprising a plurality of first structures, with corresponding first void regions, interposed between the second major surface of the first layer and the first major surface of the third layer, wherein each first structure has a first surface facing or in contact with the second major surface of the first layer and a second surface facing or in contact with the first major surface of the third layer, and wherein the first structures of the first arrangement have corresponding imaginary axes aligned perpendicular to and running through the centroids of their first surfaces;

a second arrangement comprising one or more second structures, with corresponding second void regions, interposed between the second major surface of the second layer and the second major surface of the third layer, wherein each of the one or more second structures has a first surface facing or in contact with the second major surface of the second layer and a second surface facing or in contact with the second major surface of the third layer; and wherein each first surface of the first structures and each first surface of the one or more second structures are offset from one another such that there is no overlap between each first surface of the first structures and each first surface of the one or more second structures, through the thickness of the deformable membrane, and wherein at least one of the imaginary axes of the first structures of the first arrangement is surrounded by the one or more second structures of the second arrangement such that an imaginary circle in a region of the second arrangement, having a radius r drawn around the at least one of the imaginary axes, intersects the at least one or more second structures of the second arrangement along at least 50% of the circle's circumference length.

In a fourteenth embodiment, the present disclosure provides a deformable membrane according to the thirteenth embodiment, wherein at least 50% of the corresponding imaginary axes of the first structures of the first arrangement are surrounded by the one or more second structures of the second arrangement such that an imaginary circle in the region of the second arrangement, having a radius r drawn around the imaginary axes, intersects the at least one or more second structures of the second arrangement along at least 50% of the circle's circumference length.

In a fifteenth embodiment, the present disclosure provides a deformable membrane according to the fourteenth embodiment, wherein all of the corresponding imaginary axes of the first structures of the first arrangement are surrounded by the one or more second structures of the second arrangement such that an imaginary circle in the region of the second arrangement, having a radius r drawn around the imaginary axes, intersects the at least one or more second structures of the second arrangement along at least 50% of the circle's circumference length.

In a sixteenth embodiment, the present disclosure provides a deformable membrane according to the thirteenth to fifteenth embodiments, wherein the at least one of the corresponding imaginary axes of the first structures of the first arrangement is surrounded by the one or more second structures of the second arrangement such that an imaginary circle in the region of the second arrangement, having a radius r drawn around an axis, intersects the at least one or more structures of the second arrangement along at least 70% of the circle's circumference length.

In a seventeenth embodiment, the present disclosure provides a deformable membrane according to the thirteenth to fifteenth embodiments, wherein the at least one of the corresponding imaginary axes of the first structures of the first arrangement is substantially surrounded by the one or more second structures of the second arrangement such that an imaginary circle in the region of the second arrangement, having a radius r drawn around an axis, intersects the at least one or more second structures of the second arrangement along at least 90% of the circle's circumference length.

In an eighteenth embodiment, the present disclosure provides a deformable membrane according to the thirteenth to seventeenth embodiments, wherein the deformable membrane further comprises a plurality of third structures proximate to or in contact with the second major surface of the third layer wherein each third structure coincides and overlaps, through the thickness of the deformable membrane, with a corresponding first structure of the first arrangement comprising a plurality of first structures, and the third structures are located in the void regions of the second arrangement comprising one or more second structures.

In a nineteenth embodiment, the present disclosure provides a deformable membrane according to the eighteenth embodiments, wherein the third structures are not in contact with the second major surface of the second layer.

In a twentieth embodiment, the present disclosure provides a force-sensing capacitor element comprising:

a deformable membrane according to any one of the eleventh to nineteenth embodiments

a first electrode embedded within the first layer or proximate to or in contact with one of the first and second major surfaces of the first layer; and

a second electrode embedded within the second layer or proximate to or in contact with one of the first and second major surfaces of the second layer.

In a twenty-first embodiment, the present disclosure provides a force-sensing capacitor element according to the first to tenth and twentieth embodiments, wherein the first arrangement comprising a plurality of first structures, the second arrangement comprising one or more second structures or both of the first arrangement and second arrangement is a two-dimensional arrangement of structures.

In a twenty-second embodiment, the present disclosure provides a deformable membrane according to any one of the eleventh to nineteenth embodiments, wherein the first arrangement comprising a plurality of first structures, the second arrangement comprising one or more second structures or both of the first arrangement and second arrangement is a two-dimensional arrangement of structures.

In a twenty-third embodiment, the present disclosure provides an electronic device comprising a force-sensing capacitor element according to any one the first to tenth, twentieth and twenty-first embodiments.

In a twenty-fourth embodiment, the present disclosure provides a touch screen display comprising a force-sensing capacitor element according to any one the first to tenth, twentieth and twenty-first embodiments.

In a twenty-fifth embodiment, the present disclosure provides a force-sensing capacitor element according to the first to seventh embodiments, wherein the first structures of the first arrangement have corresponding imaginary axes aligned perpendicular to and running through the centroids of their first surfaces, and wherein at least one of the imaginary axes of the first structures of the first arrangement is substantially surrounded by the one or more second structures of the second arrangement such that an imaginary perimeter in a region of the second arrangement intersects the at least one or more second structures of the second arrangement along at least 50% of the perimeter length, wherein the imaginary perimeter is drawn perpendicular to and around the imaginary axis of a first structure, has an identical shape as that of the perimeter of the first structure and has a size scaled to be greater than at least one times the perimeter of the first structure.

In a twenty-sixth embodiment, the present disclosure provides a force-sensing capacitor element according to the first to seventh embodiments, wherein the first structures of the first arrangement have corresponding imaginary axes aligned perpendicular to and running through the centroids of their first surfaces, and wherein at least one of the imaginary axes of the first structures of the first arrangement is substantially surrounded by the one or more second structures of the second arrangement such that an imaginary perimeter in a region of the second arrangement intersects the at least one or more second structures of the second arrangement along at least 50% of the perimeter length, wherein the imaginary perimeter is drawn perpendicular to and around the imaginary axis of a first structure and has been enlarged by an arbitrary distance relative to the perimeter of the first surface of the first structure and wherein the arbitrary distance is no greater than the length of the force sensing capacitor element.

In a twenty-seventh embodiment, the present disclosure provides a deformable membrane for a force-sensing capacitor element comprising:

a first layer having first and second major surfaces;

a second layer having first and major second surfaces;

a third layer having first and second major surfaces interposed between the second major surface of the first layer and the second major surface of the second layer;

a first arrangement comprising a plurality of first structures, with corresponding first void regions, interposed between the second major surface of the first layer and the first major surface of the third layer, wherein each first structure has a first surface facing or in contact with the second major surface of the first layer and a second surface facing or in contact with the first major surface of the third layer, and wherein the first structures of the first arrangement have corresponding imaginary axes aligned perpendicular to and running through the centroids of their first surfaces;

a second arrangement comprising one or more second structures, with corresponding second void regions, interposed between the second major surface of the second layer and the second major surface of the third layer, wherein each of the one or more second structures has a first surface facing or in contact with the second major surface of the second layer and a second surface facing or in contact with the second major surface of the third layer; and wherein each first surface of the first structures and each first surface of the one or more second structures are offset from one another such that there is no overlap between each first surface of the first structures and each first surface of the one or more second structures, through the thickness of the deformable membrane, and wherein at least one of the imaginary axes of the first structures of the first arrangement is substantially surrounded by the one or more second structures of the second arrangement such that an imaginary perimeter in a region of the second arrangement intersects the at least one or more second structures of the second arrangement along at least about 50% of the perimeter length, wherein the imaginary perimeter is drawn perpendicular to and around the imaginary axis of a first structure, has an identical shape as that of the perimeter of the first structure and has a size scaled to be greater than at least one times the perimeter of the first structure.

In a twenty-eighth embodiment, the present disclosure provides a deformable membrane for a force-sensing capacitor element comprising:

a first layer having first and second major surfaces;

a second layer having first and major second surfaces;

a third layer having first and second major surfaces interposed between the second major surface of the first layer and the second major surface of the second layer;

a first arrangement comprising a plurality of first structures, with corresponding first void regions, interposed between the second major surface of the first layer and the first major surface of the third layer, wherein each first structure has a first surface facing or in contact with the second major surface of the first layer and a second surface facing or in contact with the first major surface of the third layer, and wherein the first structures of the first arrangement have corresponding imaginary axes aligned perpendicular to and running through the centroids of their first surfaces;

a second arrangement comprising one or more second structures, with corresponding second void regions, interposed between the second major surface of the second layer and the second major surface of the third layer, wherein each of the one or more second structures has a first surface facing or in contact with the second major surface of the second layer and a second surface facing or in contact with the second major surface of the third layer; and wherein each first surface of the first structures and each first surface of the one or more second structures are offset from one another such that there is no overlap between each first surface of the first structures and each first surface of the one or more second structures, through the thickness of the deformable membrane, and wherein at least one of the imaginary axes of the first structures of the first arrangement is substantially surrounded by the one or more second structures of the second arrangement such that an imaginary perimeter in a region of the second arrangement intersects the at least one or more second structures of the second arrangement along at least about 50% of the perimeter length, wherein the imaginary perimeter is drawn perpendicular to and around the imaginary axis of a first structure, has been enlarged by an arbitrary distance relative to the perimeter of the first surface of the first structure and the arbitrary distance is no greater than the length of the force sensing capacitor element.

In a twenty-ninth embodiment, the present disclosure provides a force-sensing capacitor element comprising:

a first layer having first and second major surfaces,

a second layer having first and second major surfaces,

a third layer having first and second major surfaces interposed between the second major surface of the first layer and the second major surface of the second layer,

a first arrangement comprising a plurality of first structures, with corresponding first void regions, interposed between the second major surface of the first layer and the first major surface of the third layer, wherein each first structure has a first surface facing or in contact with the second major surface of the first layer and a second surface facing or in contact with the first major surface of the third layer, and

a second arrangement comprising one or more second structures, with corresponding second void regions, interposed between the second major surface of the second layer and the second major surface of the third layer, wherein each of the one or more second structures has a first surface facing or in contact with the second major surface of the second layer and a second surface facing or in contact with the second major surface of the third layer; and wherein each first surface of the first structures and each first surface of the one or more second structures are offset from one another such that there is no overlap between each first surface of the first structures and each first surface of the one or more second structures, through the thickness of the force-sensing capacitor; wherein

at least one of the first layer, the second layer, and the third layer is a metal.

In a thirtieth embodiment, the present disclosure provides a force-sensing capacitor element according to the twenty-ninth embodiment, wherein the first layer is a metal.

In a thirty-first embodiment, the present disclosure provides a force-sensing capacitor element according to the twenty-ninth to thirtieth embodiments, wherein the second layer is a metal.

In a thirty-second embodiment, the present disclosure provides a force-sensing capacitor element according to the twenty-ninth to thirty-first embodiments, wherein the third layer is a metal.

In a thirty-third embodiment, the present disclosure provides a force-sensing capacitor element according to the twenty-ninth embodiment, wherein the second layer is a metal and the third layer is a metal.

In an thirty-fourth embodiment, the present disclosure provides a force-sensing capacitor element according to the twenty-ninth to thirty-third, wherein the first structures of the first arrangement have corresponding imaginary axes aligned perpendicular to and running through the centroids of their first surfaces, and wherein at least one of the imaginary axes of the first structures of the first arrangement is substantially surrounded by the one or more structures of the second arrangement such that an imaginary circle in a region of the second arrangement comprising one or more structures, having a radius r drawn around the at least one of the imaginary axes, intersects the at least one or more second structures of the second arrangement along at least 50% of the circle's circumference length.

In a thirty-fifth embodiment, the present disclosure provides a force-sensing capacitor according to the thirty-fourth embodiment, wherein at least 50% of the corresponding imaginary axes of the first structures of the first arrangement are surrounded by the one or more second structures of the second arrangement such that an imaginary circle in the region of the second arrangement, having a radius r drawn around the imaginary axes, intersects the at least one or more second structures of the second arrangement along at least 50% of the circle's circumference length.

In a thirty-sixth embodiment, the present disclosure provides a force-sensing capacitor according to the thirty-fifth embodiment, wherein all of the corresponding imaginary axes of the first structures of the first arrangement are surrounded by the one or more second structures of the second arrangement such that an imaginary circle in the region of the second arrangement, having a radius r drawn around the imaginary axes, intersects the at least one or more second structures of the second arrangement along at least 50% of the circle's circumference length.

In a thirty-seventh embodiment, the present disclosure provides a force-sensing capacitor according to the thirty-fourth to thirty-sixth embodiments, wherein the at least one of the corresponding imaginary axes of the first structures of the first arrangement is surrounded by the one or more second structures of the second arrangement such that an imaginary circle in the region of the second arrangement, having a radius r drawn around an axis, intersects the at least one or more structures of the second arrangement along at least 70% of the circle's circumference length.

In a thirty-eighth embodiment, the present disclosure provides a force-sensing capacitor according to the thirty-fourth to thirty-sixth embodiments, wherein the at least one of the corresponding imaginary axes of the first structures of the first arrangement is substantially surrounded by the one or more second structures of the second arrangement such that an imaginary circle in the region of the second arrangement, having a radius r drawn around an axis, intersects the at least one or more second structures of the second arrangement along at least 90% of the circle's circumference length.

In a thirty-ninth embodiment, the present disclosure provides a force-sensing capacitor according to the twenty-ninth to thirty-eighth embodiments, wherein the force-sensing capacitor further comprises a plurality of third structures proximate to or in contact with the second major surface of the third layer wherein each third structure coincides and overlaps, through the thickness of the force-sensing capacitor, with a corresponding first structure of the first arrangement comprising a plurality of first structures, and the third structures are located in the void regions of the second arrangement comprising one or more second structures.

In a fortieth embodiment, the present disclosure provides a force-sensing capacitor according to the thirty-ninth embodiment, wherein the third structures are not in contact with the second major surface of the second layer.

### EXAMPLES

### Materials List

Acrylic Resin 1 was a solution of 59.70 wt-% R1, 19.90 wt-% R2, 19.90 wt-% R3, and 0.5 wt-% PI1.

Acrylic Resin 2 was a 10 wt-% solution of Acrylic Resin 1 dissolved in isopropyl alcohol (90% isopropyl alcohol).

| Abbreviation | Source |
|---|---|
| R1 | Aliphatic urethane diacrylate commercially available from IGM Resins |
| | Charlotte, NC, as PHOTOMER 6210 |
| R2 | Hexanediol diacrylate commercially available from Sartomer Americas |
| | Exton, PA, as SR238 |
| R3 | Trimethylolpropane triacrylate commercially available from Sartomer |
| | Americas, Exton, PA, as SR351. |
| PI1 | Photoinitiator commercially available from BASF Corp. Wyandotte, MI, as |
| | LUCRIN TPO |
| AP1 | Acrylic Primer available from Dow Chemical Company, Midland, MI, as |
| | RHOPLEX 3208. |
| PET Film 1 | 2-mil biaxially-oriented polyethyleneterepthalate (PET) film having |
| | adhesion promoting primer coatings comprising AP1 on both major surfaces |
| PET Film 2 | 2-mil biaxially-oriented polyethyleneterepthalate (PET) film having |
| | adhesion promoting primer coating comprising AP1 on one major surface |
| | (“primed side”) |

### Testing

Force-sensing capacitor elements comprising deformable membranes were tested for uniaxial compressibility and for their capacitance change versus uniaxial applied force applied normal to their major surfaces (same as capacitance per unit area change versus uniaxial pressure). The apparatus for testing comprised a TA Instruments ARES Rheometer (TA Instruments, New Castle Del.) and an Agilent 4284 Precision LCR Meter (Agilent Technologies, Santa Clara, Calif.). The rheometer was used for application of a controlled uniaxial load and measurement of displacement (for determination of reported sample thickness) under the load. The LCR meter was used for measurement of capacitance and dissipation factor at 200 kHz, simultaneously with the application of the normal load and measurement of sample thickness. Measurements of capacitance and dissipation factor were made as load was increased and then decreased, with the load being held at set levels between and including 0 and 1 kilogram for approximately 15 seconds for each measurement. The top shaft of the rheometer were terminated with a rectangular conductive platen made of brass, with lateral dimensions of approximately 1.03 centimeter by approximately 1.13 centimeter, giving an area of approximately 1.16 square centimeters. The bottom shaft of the rheometer was terminated with a circular conductive platen made of stainless steel, with diameter of 2.5 centimeters. The deformable membrane components of Examples 1-4, Comparative Example 5, and Examples 6-8 were all cut to approximately the same lateral dimensions of the top platen and aligned within the platens. Thus, 1.16 square centimeters is the area of each of the parallel plate capacitors and is the area over which the reported loads (also referred to herein as forces) were distributed. The pressure applied to the force-sensing capacitor elements and the deformable membranes was equal to the reported loads divided by 1.16 centimeters squared (i.e., square centimeters, also denoted cm̂2). The capacitance per unit area of the force-sensing capacitor elements was equal to the reported capacitance values divided by 1.16 centimeters squared. When connected to a force-sensing capacitor element of any of Examples 1-8, the LCR meter constituted drive electronics used to measure the capacitance of the capacitor element and the change in capacitance of the capacitor element with compression.

### Examples 1-4

### Force-Sensing Capacitor Elements with Metal First and Second Layers

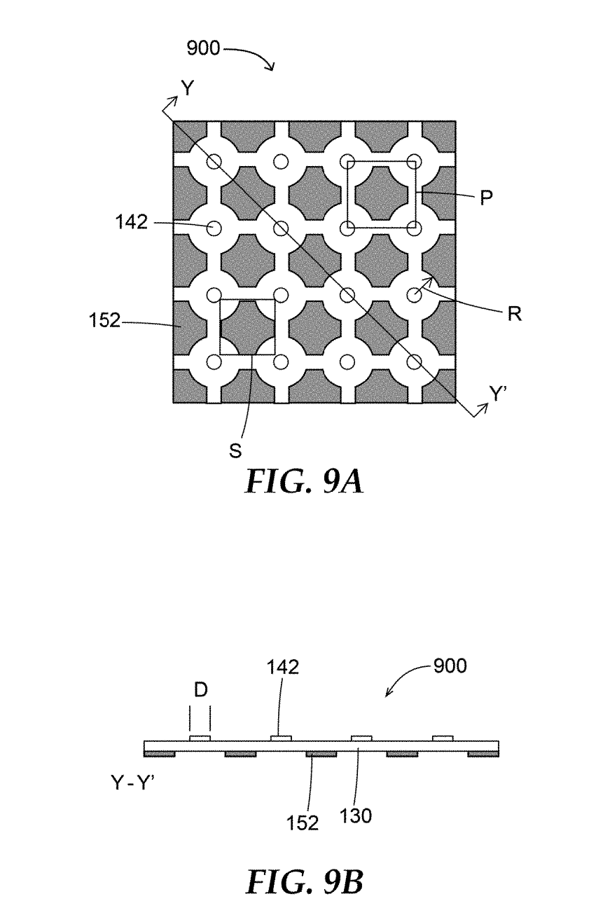

Force-sensing capacitor elements according to FIGS. 3A and 3B were fabricated. The metal platens of the rheometer constituted the first layer 110 and the second layer 120 of the compressible capacitor elements of Examples 1-4. A piece of PET Film 1 of approximately A4 size (approximately 20 centimeters by 30 centimeters) was provided as third layer with a first major surface and a second major surface. Structures were fabricated on the first major surface and the second major surface of the third layer. A third layer for each of Examples 1-4, with its first structures and its second structures, is referred to herein as a structured core 900, as depicted in FIGS. 9A and 9B.

Tools were fabricated for molding structures onto the major surfaces of the third layer. Each tool comprised a pattern of polyimide film (0.002 inch thick) applied to a sheet of precision rolled aluminum sheet stock (Lorin Industries Inc., Alloy 1085, 0.025 inch thick). The tool was patterned by excimer laser ablation as described in U.S. Pat. No. 6,285,001. The resulting relief height of the tooling was approximately 50 micrometers, the thickness of the polyimide film. For each structured core of Examples 1-4, a first tool was so prepared for molding first structures and a second tool was so prepared for molding second structures.

A plurality of first structures were formed onto the first surface of the third layer by molding Acrylic Resin 1 between the first surface of the third layer and a first tool. Acrylic Resin 1 was applied to the first tool which had been heated in an air-circulation batch oven set at 75 deg. C. Once the resin was allowed to wet-out the surface of the tool (about 2 minutes), the tool with liquid resin layer was introduced into a batch vacuum oven set at 50 deg, C. and vacuum was applied. Vacuum was allowed to reach ˜25 in. Hg then vacuum was turned off and sample was allowed to slowly return to atmospheric pressure. Next, the sheet of the PET Film 1 was laid over tool/resin stack and laminated using a flat-bed laminator equipped with a 4″ silicone rubber roll of approximately 50 Durameter. The resulting multilayer stack (first tool, resin layer, and PET layer) was then cured in a broad spectrum carbon lamp UV curing chamber with a belt speed of 50 FPM. The stack was processed through the UV system three times then allowed to return to room temperature. At this point, a sharp tool is inserted between first tool surface and microreplicated film surface to initiate separation of the two layers (first tool and film), and continuous upward force was applied to the film to facilitate separation from the tool.

A plurality of second structures were formed onto the second surface of the third layer by molding Acrylic Resin 1 between the second surface of the third layer and the second tool. The second structures were molded according to a similar procedure as used for the first structures, with two modifications. The first modification was the temporary addition of a 0.003 inch thick film of polyethyeleneterepthalate (PET) was placed between the first structures of the third layer and the silicone rubber roller of the flat-bed laminator. This 0.003 inch thick film of PET was removed after the lamination step and was not a component in the final articles. The second modification to the procedure was the manual offset-placement of the first structures with respect to the second tool, to yield structured cores with first structures offset from second structures.

The first structures were connected by a land region having a height that was estimated to be less than 25 micrometers (i.e., less than 50% of the height of the first structures). The second structures were connected by a land region having a height that was estimated to be less than 25 micrometers (i.e., less than 50% of the height of the second structures). A third layer for each of Examples 1-4, with its first structures and its second structures, is referred to herein as a structure core.

The structured cores of Examples 1-4 were fabricated with designs according to FIG. 9A, FIG. 9B, and Table 1. The designs for the structured cores 900 varied in the dimensions D, P, S, and R, as depicted in FIG. 9A and listed in Table 1. Table 1 also lists the fill factor for the first surfaces of the first structures (denoted first fill factor), the fill factor for the first surfaces of the second structures (denoted second fill factor), and the total factor (defined as the sum of the first fill factor and the second fill factor). Furthermore, Table 1 lists the proportion (or amount) by which second structures surround first structures, as described above with respect to FIGS. 3A and 3B and in terms of the proportion or amount of circumference length intersected by second structures for an imaginary circle C1 centered on an imaginary axis aligned perpendicular and running through the centroids of the first surfaces of the first structures.

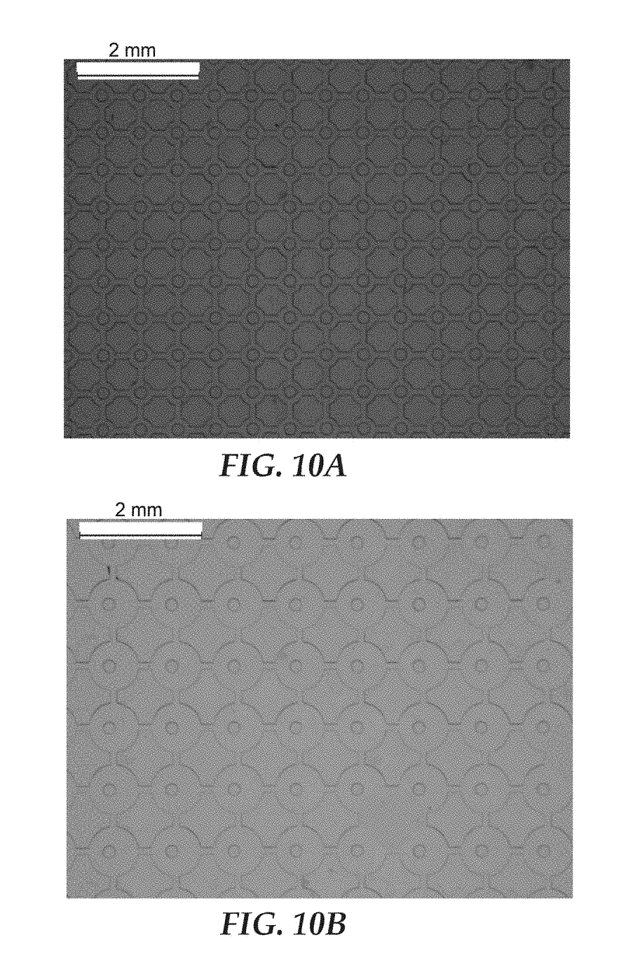

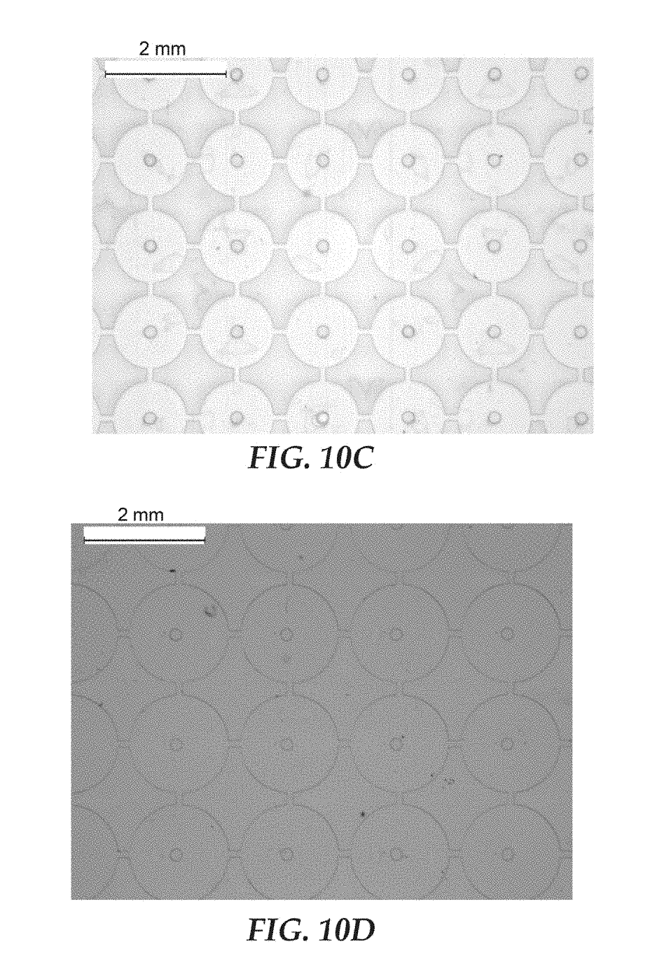

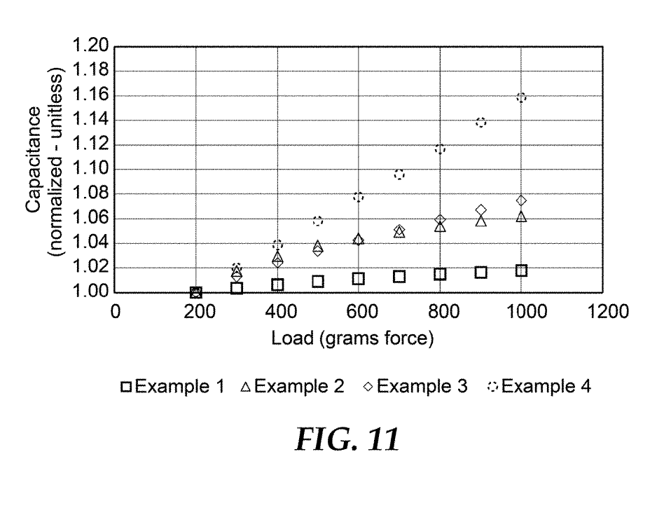

FIGS. 10A-10D gives plan view optical photomicrographs of the structured cores of Examples 1-4, respectively. Table 2 reports measured structured core thickness and capacitance versus applied load for the capacitor elements of Examples 1-4. FIG. 11 gives a plot of normalized capacitance vs. force for each of the examples during loading, using data reported in Table 2. For FIG. 11, the capacitance values were normalized to (i.e., divided by) the capacitance measured at 200 grams force during loading, the value of which for each example is reported in Table 2. The reasons for normalizing according to this procedure were as follows. Normalization allows for multiple samples having different starting capacitance values to be compared graphically in terms of their changes in capacitance relative to their starting or initial capacitance. Also, in some cases, capacitance versus load and thickness versus load behavior below 200 grams force was spurious, suggesting that curvature in the structured cores may have been variably eliminated in the lower load regime (e.g., 0 grams force to 200 grams force) as the first and second layers (metal platens) were applied.

For each capacitor element, a value of capacitance change per unit force (dC/dF, in units of femtofarads per gram force) was calculated using the slope of a regression fit of capacitance vs. force, from 200 grams force (1.96 newtons) to 1000 grams force (9.8 newtons). Values of dC/dF are also reported in Table 1. Values of the coefficient of determination (denoted RSQ) for capacitance per unit area versus force per unit area (same as coefficient of determination for capacitance versus force) in the regime of 200 grams force to 1000 grams force over the sample area of 1.16 square centimeters, a measure of the linearity of the capacitance versus force response, are also given in Table 1. Regarding the RSQ values in Table 1, force was varied over a factor of 5 (1000 grams force divided by 200 grams force).

TABLE 1
Structured core design parameters and selected testing results for the force-sensing capacitor elements of Examples 1-4.

| | | | | | | | | Amount of | | |
|---|---|---|---|---|---|---|---|---|---|---|
| | | | | | | | | Circumference | | |
| | | | | | | | | Length by which | | |
| | D | P | S | R | First | Second | Total | Second Structures | dC/dF | |
| | (microm- | (microm- | (microm- | (microm- | Fill | Fill | Fill | Surround First | (fF/gm- | |
| | eters) | eters) | eters) | eters) | Factor | Factor | Factor | Structures | force) | RSQ |
| Example 1 | 200 | 600 | 500 | 200 | 8.7% | 53.6% | 62.4% | 78.8% | 0.23 | 0.9764 |
| Example 2 | 200 | 1000 | 900 | 400 | 3.1% | 45.7% | 48.8% | 87.3% | 0.77 | 0.9293 |
| Example 3 | 200 | 1400 | 1300 | 600 | 1.6% | 40.2% | 41.8% | 90.9% | 1.02 | 0.9925 |
| Example 4 | 200 | 1800 | 1700 | 800 | 1.0% | 36.7% | 37.7% | 92.9% | 2.21 | 0.9996 |

TABLE 2
Raw data for testing of the force-sensing capacitor elements of Examples 1-4.

| | Example 1 | | Example 2 | | Example 3 | | Example 4 | |
|---|---|---|---|---|---|---|---|---|
| | Thick- | | Thick- | | Thick- | | Thick- | |
| Load | ness | Capaci- | ness | Capaci- | ness | Capaci- | ness | Capaci- |
| (grams | (microm- | tance | (microm- | tance | (microm- | tance | (microm- | tance |
| force) | eters) | (pF) | eters) | (pF) | eters) | (pF) | eters) | (pF) |
| 0 | 202 | 9.660 | 236 | 7.679 | 195 | 10.059 | 188 | 10.352 |
| 25 | 193 | 10.213 | 221 | 8.267 | 188 | 10.524 | 185 | 10.554 |
| 50 | 189 | 10.311 | 206 | 8.944 | 185 | 10.709 | 181 | 10.741 |
| 75 | 186 | 10.377 | 195 | 9.585 | 182 | 10.832 | 179 | 10.843 |
| 100 | 182 | 10.426 | 187 | 10.003 | 180 | 10.913 | 176 | 10.939 |
| 125 | 180 | 10.456 | 183 | 10.247 | 178 | 10.976 | 174 | 11.019 |
| 150 | 178 | 10.487 | 179 | 10.441 | 176 | 11.041 | 172 | 11.093 |
| 175 | 176 | 10.505 | 175 | 10.663 | 174 | 11.085 | 170 | 11.157 |
| 200 | 174 | 10.518 | 173 | 10.758 | 172 | 11.135 | 168 | 11.221 |
| 300 | 168 | 10.556 | 166 | 10.945 | 166 | 11.279 | 161 | 11.445 |
| 400 | 163 | 10.613 | 160 | 11.076 | 159 | 11.404 | 154 | 11.655 |
| 500 | 157 | 10.636 | 153 | 11.166 | 153 | 11.511 | 146 | 11.873 |
| 600 | 151 | 10.654 | 148 | 11.230 | 147 | 11.609 | 139 | 12.091 |
| 700 | 147 | 10.674 | 142 | 11.287 | 141 | 11.704 | 133 | 12.299 |
| 800 | 141 | 10.689 | 137 | 11.337 | 135 | 11.797 | 125 | 12.532 |
| 900 | 136 | 10.704 | 132 | 11.385 | 129 | 11.884 | 118 | 12.773 |
| 1000 | 131 | 10.697 | 126 | 11.427 | 124 | 11.966 | 112 | 13.001 |
| 900 | 136 | 10.686 | 131 | 11.406 | 129 | 11.903 | 118 | 12.815 |
| 800 | 141 | 10.675 | 137 | 11.377 | 135 | 11.835 | 125 | 12.617 |
| 700 | 146 | 10.661 | 142 | 11.344 | 140 | 11.761 | 131 | 12.418 |
| 600 | 151 | 10.646 | 147 | 11.311 | 147 | 11.683 | 137 | 12.226 |
| 500 | 156 | 10.628 | 153 | 11.262 | 152 | 11.604 | 144 | 12.022 |
| 400 | 161 | 10.608 | 158 | 11.209 | 158 | 11.509 | 151 | 11.820 |
| 300 | 167 | 10.580 | 164 | 11.137 | 164 | 11.400 | 158 | 11.618 |
| 200 | 172 | 10.559 | 170 | 11.021 | 170 | 11.274 | 165 | 11.406 |
| 150 | 175 | 10.538 | 174 | 10.906 | 173 | 11.193 | 169 | 11.285 |
| 100 | 178 | 10.500 | 178 | 10.700 | 177 | 11.098 | 173 | 11.149 |
| 50 | 181 | 10.308 | 184 | 10.171 | 181 | 10.956 | 177 | 10.986 |
| 0 | 189 | | 211 | 8.792 | 188 | 10.592 | 183 | 10.662 |

### Comparative Example 5 and Examples 6-8

### Force-Sensing Capacitor Elements Comprising a Deformable Membrane

The structured cores 900 of Examples 1-4 were used to prepare deformable membranes of Comparative Example 5 and Examples 6-8, respectively. Each of the deformable membranes of Comparative Example 5 through Example 8 included a first layer 110 and a second layer 120, each comprising a polymer film, bonded to structures 142 and structures 152, respectively. Furthermore, gold electrodes were applied to the first major surface 110a of the first layer 110 and the first major surface 120a of the second layer 120 (with reference to FIG. 1A).

Each deformable membrane of Comparative Examples 5 through Example 8 was assembled as follows. A first piece of PET Film 2 of approximately A4 size (approximately 20 centimeters by 30 centimeters) was provided as a first layer with a first major surface and a second major surface (primed side). A second piece of PET Film 2 of approximately A4 size (approximately 20 centimeters by 30 centimeters) was provided as a second layer with a first major surface and a second major surface (primed side). The second major surfaces of the first and second layers were resin bonded to the first and second structures, respectively, according to the following procedure. The respective piece of PET Film 2 was applied to a flat sheet of glass with the primed side facing up. A layer of Acrylic Resin 2 was applied to the primed face of the piece of PET Film 2 using a self- contained sprayer system (Chicago Aerosol, Bridgeview, Ill.). Application of this layer can be facilitated by any atomization system such as an automotive spray gun or an air brush system. Optionally, for the preparation of Acrylic Resin 2, the concentration of Acrylic Resin 1 in isopropanol can be increased, for example to 20 wt-%. The glass plate, PET Film 2 and Acrylic Resin 2 stack was then placed in a forced air circulation batch furnace set at 50 Deg. C. and Isopropyl Alcohol was allowed to evaporate off over 5 minutes. One at a time, each respective first and second structures that had been molded onto the third layer were laid down into the layer of Acrylic Resin 2, laminated with flat-bed laminator using a clean piece of PET between sample and roll, then cured in the aforementioned UV curing system. The first structures were bonded to the second major surface of the first layer. The second structures were bonded to the second major surface of the second layer.

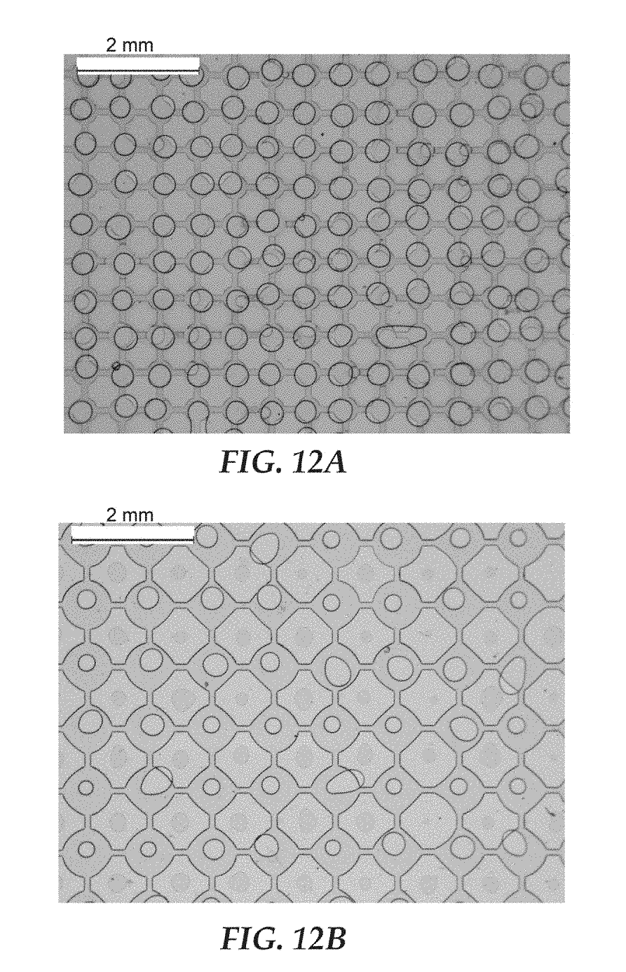

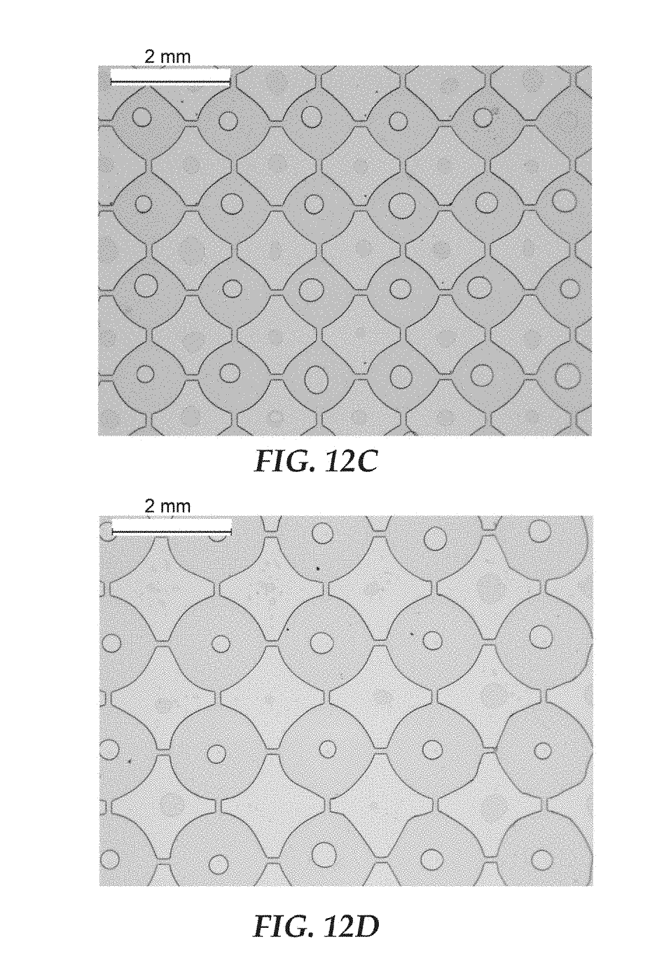

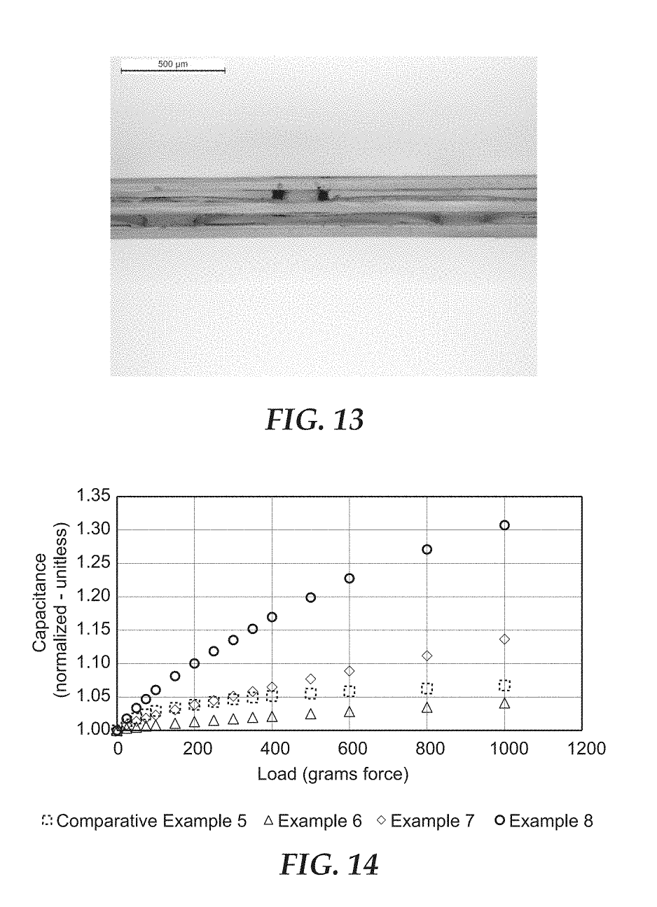

FIGS. 12A-12D gives plan view optical photomicrographs of the deformable membranes of Comparative Example 5 through Example 8 (before application of the gold electrodes), respectively. FIG. 13 gives a cross section optical photomicrograph of the multi-layer deformable membrane of Example 7 (before application of the gold electrodes). As illustrated in FIG. 12A, the procedure for bonding a first layer and a second layer to the structured core of Example 1 yielded a substantial degree of overlap for the first surfaces of first structures and the first surfaces of the second structures in the force-sensing capacitor of Comparative Example 5. Thus, the first surfaces of the first structures are not offset from the first surfaces of the second structures. After bonding the first and second layers to the structures formed on the third layer, gold electrodes (100 nm thickness, with 5 angstrom thickness titanium adhesion promotion layer) were evaporated onto the first major surfaces of the first and second layers (outside surfaces of the membrane) using standard techniques, thus yielding force-sensing capacitor elements comprising deformable membranes.

Table 3 reports measured thickness and capacitance versus applied load for the force-sensing capacitor elements of Comparative Example 5 through Example 8. FIG. 14 gives a plot of normalized capacitance vs. force for each of the force-sensing capacitor elements of Comparative Example 5 through Example 8 during loading, using data reported in Table 3. For FIG. 14, the capacitance values for each capacitor were normalized to (i.e., divided by) that capacitor's initial capacitance value before loading, the value of which for each example is reported in Table 3 (0 grams force, top row). For each capacitor element, a value of capacitance change per unit force (dC/dF) was calculated using the slope of a regression fit of capacitance vs. force, from 200 grams force (1.96 newtons) to 1000 grams force (9.8 newtons). Values of dC/dF are reported in Table 4. Values of the coefficient of determination (denoted RSQ) for capacitance per unit area versus force per unit area (same as coefficient of determination for capacitance versus force) in the regime of 200 grams force to 1000 grams force over the sample area of 1.16 square centimeters, a measure of the linearity of the capacitance versus force response, are also given in Table 4. Regarding the RSQ values in Table 4, force is varied over a factor of 5 (1000 grams force divided by 200 grams force). A total fill factor was measured for each of Examples 6-8. The total fill factor was determined with image analysis tools, as is known in the art, using Image J software (National Institutes of Health, Bathesda, Md.) and the images of FIG. 12. The measured total fill factor values are given in Table 4.

TABLE 3
Raw data from testing of the force-sensing capacitor
elements of Comparative Example 5 through Example 8.

| | Comparative | | | | | | | |
|---|---|---|---|---|---|---|---|---|
| | Example 5 | | Example 6 | | Example 7 | | Example 8 | |
| | Thick- | | Thick- | | Thick- | | Thick- | |
| Load | ness | Capaci- | ness | Capaci- | ness | Capaci- | ness | Capaci- |
| (grams | (microm- | tance | (microm- | tance | (microm- | tance | (microm- | tance |
| force) | eters) | (pF) | eters) | (pF) | eters) | (pF) | eters) | (pF) |
| 0 | 319 | 9.351 | 280 | 10.763 | 284 | 11.119 | 287 | 9.928 |
| 25 | 308 | 9.436 | 272 | 10.797 | 277 | 11.209 | 280 | 10.104 |
| 50 | 303 | 9.519 | 269 | 10.816 | 273 | 11.270 | 276 | 10.260 |
| 75 | 301 | 9.576 | 267 | 10.834 | 270 | 11.323 | 272 | 10.393 |
| 100 | 298 | 9.624 | 265 | 10.851 | 268 | 11.374 | 268 | 10.529 |
| 150 | 294 | 9.668 | 261 | 10.877 | 263 | 11.459 | 262 | 10.735 |
| 200 | 290 | 9.711 | 257 | 10.903 | 259 | 11.544 | 257 | 10.922 |
| 250 | 286 | 9.749 | 254 | 10.925 | 255 | 11.617 | 252 | 11.104 |
| 300 | 282 | 9.786 | 251 | 10.948 | 251 | 11.688 | 247 | 11.273 |
| 350 | 279 | 9.812 | 247 | 10.971 | 247 | 11.765 | 243 | 11.438 |
| 400 | 276 | 9.833 | 245 | 10.990 | 244 | 11.840 | 238 | 11.613 |
| 500 | 270 | 9.866 | 238 | 11.031 | 237 | 11.977 | 229 | 11.905 |
| 600 | 264 | 9.897 | 232 | 11.066 | 230 | 12.108 | 221 | 12.188 |
| 800 | 253 | 9.939 | 221 | 11.137 | 218 | 12.362 | 207 | 12.618 |
| 1000 | 242 | 9.980 | 209 | 11.205 | 205 | 12.639 | 193 | 12.980 |
| 800 | 252 | 9.966 | 221 | 11.148 | 216 | 12.445 | 205 | 12.793 |
| 600 | 262 | 9.942 | 232 | 11.085 | 228 | 12.217 | 218 | 12.452 |
| 500 | 268 | 9.925 | 237 | 11.052 | 235 | 12.082 | 226 | 12.198 |
| 400 | 273 | 9.904 | 243 | 11.017 | 241 | 11.949 | 233 | 11.917 |
| 350 | 277 | 9.891 | 246 | 10.999 | 245 | 11.871 | 238 | 11.746 |
| 300 | 280 | 9.874 | 249 | 10.976 | 249 | 11.797 | 242 | 11.591 |
| 250 | 283 | 9.858 | 252 | 10.956 | 252 | 11.724 | 248 | 11.398 |
| 200 | 286 | 9.837 | 256 | 10.934 | 256 | 11.651 | 252 | 11.240 |
| 150 | 290 | 9.809 | 259 | 10.913 | 260 | 11.569 | 258 | 10.987 |
| 100 | 293 | 9.772 | 263 | 10.888 | 264 | 11.482 | 263 | 10.847 |
| 75 | 295 | 9.746 | 265 | 10.875 | 266 | 11.433 | 265 | 10.742 |
| 50 | 298 | 9.710 | 266 | 10.863 | 269 | 11.385 | 268 | 10.637 |
| 25 | 301 | 9.663 | 269 | 10.846 | 272 | 11.321 | 272 | 10.519 |
| 0 | 308 | 9.499 | 273 | 10.819 | 278 | 11.236 | 278 | 10.366 |

TABLE 4
Structured core design parameters and selected testing results for the force-
sensing capacitor elements of Comparative Examples 5 through Example 8.

| | | | | | | | | Amount of | | |
|---|---|---|---|---|---|---|---|---|---|---|
| | | | | | First Fill | Second Fill | Total Fill | Circumference | | |
| | | | | | Factor of | Factor of | Factor of | Length by which | | |
| | D | P | S | R | Structured | Structured | Deformable | Second Structures | dC/dF | |
| | (microm- | (microm- | (microm- | (microm- | Core before | Core before | Membrane | Surround First | (fF/gm- | |
| | eters) | eters) | eters) | eters) | Assembly | Assembly | (measured) | Structures | force) | RSQ |
| Comparative | 200 | 600 | 500 | 200 | 8.7% | 53.6% | N/A | 78.8% | 0.32 | 0.9384 |
| Example 5 | | | | | | | | | | |
| Example 6 | 200 | 1000 | 900 | 400 | 3.1% | 45.7% | 61.7% | 87.3% | 0.38 | 0.9971 |
| Example 7 | 200 | 1400 | 1300 | 600 | 1.6% | 40.2% | 51.1% | 90.9% | 1.36 | 0.9993 |
| Example 8 | 200 | 1800 | 1700 | 800 | 1.0% | 36.7% | 42.6% | 92.9% | 2.59 | 0.9847 |

What is claimed is:

1. A deformable membrane for a force-sensing capacitor element comprising:
a first layer having first and second major surfaces;
a second layer having first and major second surfaces;
a third layer having first and second major surfaces interposed between the second major surface of the first layer and the second major surface of the second layer;
a first arrangement comprising a plurality of first structures, with corresponding first void regions, interposed between the second major surface of the first layer and the first major surface of the third layer, wherein each first structure has a first surface facing the second major surface of the first layer and a second surface facing the first major surface of the third layer, and wherein the first structures of the first arrangement have corresponding imaginary axes aligned perpendicular to and running through the centroids of their first surfaces;
a second arrangement comprising one or more second structures, with corresponding second void regions, interposed between the second major surface of the second layer and the second major surface of the third layer, wherein each of the one or more second structures has a first surface facing the second major surface of the second layer and a second surface proximate facing the second major surface of the third layer; and wherein each first surface of the first structures and each first surface of the one or more second structures are offset from one another such that there is no overlap between each first surface of the first structures and each first surface of the one or more second structures, through the thickness of the deformable membrane, and wherein at least one of the imaginary axes of the first structures of the first arrangement is surrounded by the one or more second structures of the second arrangement such that an imaginary circle in a region of the second arrangement, having a radius r drawn around the at least one of the imaginary axes, intersects the at least one or more second structures of the second arrangement along at least 50% of the circle's circumference length.

2. The deformable membrane of claim 1, wherein at least 50% of the corresponding imaginary axes of the first structures of the first arrangement are surrounded by the one or more second structures of the second arrangement such that an imaginary circle in the region of the second arrangement, having a radius r drawn around the imaginary axes, intersects the at least one or more second structures of the second arrangement along at least 50% of the circle's circumference length.

3. The deformable membrane of claim 1, wherein all of the corresponding imaginary axes of the first structures of the first arrangement are surrounded by the one or more second structures of the second arrangement such that an imaginary circle in the region of the second arrangement, having a radius r drawn around the imaginary axes, intersects the at least one or more second structures of the second arrangement along at least 50% of the circle's circumference length.

4. The deformable membrane of claim 1, wherein the at least one of the corresponding imaginary axes of the first structures of the first arrangement is surrounded by the one or more second structures of the second arrangement such that an imaginary circle in the region of the second arrangement, having a radius r drawn around an axis, intersects the at least one or more structures of the second arrangement along at least 70% of the circle's circumference length.

5. The deformable membrane of claim 1, wherein the at least one of the corresponding imaginary axes of the first structures of the first arrangement is substantially surrounded by the one or more second structures of the second arrangement such that an imaginary circle in the region of the second arrangement, having a radius r drawn around an axis, intersects the at least one or more second structures of the second arrangement along at least 90% of the circles circumference length.

6. The deformable membrane of claim 1, wherein the deformable membrane further comprises a plurality of third structures proximate to or in contact with the second major surface of the third layer wherein each third structure coincides and overlaps, through the thickness of the deformable membrane, with a corresponding first structure of the first arrangement comprising a plurality of first structures, and the third structures are located in the void regions of the second arrangement comprising one or more second structures.

7. The deformable membrane of claim 6, wherein the third structures are not in contact with the second major surface of the second layer.

8. The deformable membrane of claim 1, wherein the total fill factor of the first surfaces of the first and second structures is between 10% and 65%.

9. A force-sensing capacitor element comprising:
a deformable membrane of claim 1;
a first electrode embedded within the first layer or proximate to or in contact with one of the first and second major surfaces of the first layer; and
a second electrode embedded within the second layer or proximate to or in contact with one of the first and second major surfaces of the second layer.

10. An electronic device comprising a force-sensing capacitor element of claim 9.

11. A touch screen display comprising a force-sensing capacitor element of claim 9.
